(19) United States
(12) Patent Application Publication
(10) Pub. No.: US 2023/0159790 A1
(43) Pub. Date: May 25, 2023

(54) SILANE-BASED COATING COMPOSITIONS COMPRISING A METAL ALKOXIDE CATALYST AND AN ACID-FUNCTIONAL POLYMER

(71) Applicant: BASF COATINGS GMBH, Münster (DE)

(72) Inventors: Jan WINSBERG, Muenster (DE); Karin HOMANN, Muenster (DE); Guenter KLEIN, Muenster (DE); Ulrike WENKING, Muenster (DE)

(21) Appl. No.: 17/915,425

(22) PCT Filed: Mar. 23, 2021
(86) PCT No.: PCT/EP2021/057417

§ 371 Date: Sep. 28, 2022

(30) Foreign Application Priority Data
Apr. 2, 2020 (EP) 20167654.1

(51) Int. Cl. C09D 183/08; C09D 7/63

(52) U.S. Cl. CPC C09D 183/08; C09D 7/63

(57) ABSTRACT

Described herein are silane-based coating compositions, including a metal alkoxide catalyst as well as an acid-functional polymer. Also described herein is a method of coating substrates with the coating compositions and coated substrates obtained by said method. Further, described herein are multilayer coatings and substrates coated with said multilayer coatings.

The present invention relates to silane-based coating compositions, particularly clearcoat compositions, comprising a metal alkoxide catalyst as well as an acid-functional polymer. Moreover, the present invention relates to a method of coating substrates with such coating compositions and coated substrates obtained by said method. Finally, the present invention relates to multilayer coatings and substrates coated with said multilayer coatings.

### STATE OF THE ART

In today’s clearcoat industry, the application of isocyanates as crosslinkers and tin catalysts becomes more and more undesired because legal classifications and maximum permissible values are getting critical.

However, polyisocyanates are commonly used crosslinker materials in many coating systems, especially clearcoats. Reasonable alternatives that fulfill future environmental, health and safety requirements, and also technological minimum requirements are not yet available. In order to increase the economic efficiency of the coating process, quickly low-temperature-curing coating systems are desired.

However, coatings based solely on the condensation of alkoxy silanes show often unfavored properties like severe post curing and brittle films, which made them unsuitable as clearcoats in automotive applications. Especially, automotive refinish applications require tailormade clearcoats due to the application of non-crosslinked basecoats.

Good performing alkoxy-silane-crosslinked clearcoats for automobile applications in general and particularly for refinish applications are not yet available, since important parameters like fast curing, quick sandability and polishability, scratch resistance, good appearance, interlayer adhesion, resistance to humidity and UV irradiation as well as high flexibility can currently not be sufficiently achieved with said clearcoats.

EP 2 641 925 A1 discloses coating compositions containing adducts of isocyanatoalkyl trialkoxysilanes with diols. These adducts were however used in the examples of EP 2 641 925 A1 together with high amounts of polyacrylate polyols. When used as sole resin with suitable crosslinking catalysts, for example potassium neodecanoate and DBU, these adducts show a comparably long tack free time and bad cross-cut adhesion, even before carrying out a constant climate test.

WO 03/054049 discloses isocyanato-functional silanes as adhesion promotors in polyurethane-based adhesives or coating materials. However, these silanes are isocyanate containing, which is to be avoided in the present invention.

JP-A-2005 015644 describes adducts of polyisocyanates with aminosilanes at an NCO to OH ratio from 1:0.05 to 1:0.9, i.e. with an excess of isocyanate groups. These adducts are used in curable resin compositions together with further resins.

Of advantage accordingly would be a preferably isocyanate-free coating composition, preferably clearcoat composition, which can be produced at low costs and which can be cured at low temperatures. The obtained coatings should exhibit good mechanical and optical properties, especially low short wave values, as well as a high flexibility. Furthermore, the use of tin containing catalysts should be avoided.

### Object

The object of the present invention, accordingly, was that of providing a fast curing coating composition, preferably clear coating composition, which can be cured at low temperatures without the use of isocyanate or aminoplast crosslinkers and tin containing catalysts. The coating composition should be particularly suitable in automotive coating such as automotive OEM and automotive refinish coating. The coating composition should have a high pot life and should be producible with low overall material costs. The coatings obtained from said coating composition should be solvent resistant, exhibiting good adhesion, scratch resistance as well as UV and weathering resistance, a high gloss, a good appearance as well as an improved flexibility.

### Technical Solution

The objects described above are achieved by the subject matter claimed in the claims and also by the preferred embodiments of that subject matter that are described in the description hereinafter.

A first subject of the present invention is therefore a coating composition comprising:
a) at least one silane-based compound R1 having an isocyanate content of less than 1 % and comprising at least one silane group of general formula (I)

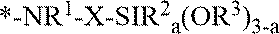

and optionally at least one silane group of general formula (II)

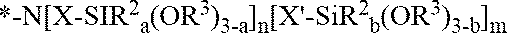

wherein
   X, X′ are, independently from each other, linear and/or branched alkylene or cycloalkylene radicals having 1 to 20 carbon atoms;
   R¹ is an alkyl group containing 1 to 10 carbon atoms,
   R² R³ are, independently from each other, alkyl, cycloalkyl, aryl, or aralkyl groups, it being possible for the carbon chain of the alkyl, cycloalkyl, aryl, or aralkyl groups to be interrupted by nonadjacent oxygen, sulfur or NRₐ groups, where Rₐ is alkyl, cycloalkyl, aryl, or aralkyl,
   n, m being, independently from each other, 0 to 2, with the proviso that m+n = 2,
   a, b being, independently from each other, 0 to 2;
b) at least one catalyst C1 of general formula (III)

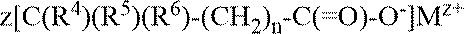

wherein
   R⁴ to R⁶ are, independently from each other, hydrogen or alkyl groups containing 1 to 6 carbon atoms, with the proviso that the sum of the number of carbon atoms in residues R⁴ to R⁶ ranges from 3 to 8;
   z being 1 to 4; and
   n being 0 or 1 to 8 with the proviso that,
   if z = 1, then M is selected from the group consisting of Li, K and Na;
   if z = 2, then M is selected from the group consisting of Zn and Zr;
   if z = 3, then M is selected from the group consisting of Bi and Al;
   if z = 4, then M is selected from the group consisting of Zr and Ti;
   c) at least one metal alkoxide C2;
   d) at least one polymer P1 having an acid number of more than 10 mg KOH/g solids, as determined according to DIN EN ISO 2114:2002-06 (procedure A); and
   e) one or more aprotic organic solvents.

The above-specified coating compositions are hereinafter also referred to as coating compositions of the invention and accordingly are a subject of the present invention. Preferred embodiments of the coating compositions of the invention are apparent from the description hereinafter and also from the dependent claims.

In light of the prior art it was surprising and unforeseeable for the skilled worker that the object on which the invention is based could be achieved by using a specific silane-based compound R1 and acid-functional polymer P1 in combination with a specific catalyst mixture C1 and C2. The use of said silane-based compound R1 and acid-functional polymer P1 in combination with the specific catalysts C1 and C2 results in low curing coating compositions which provide coating layers having excellent mechanical and optical properties without the use of isocyanate or aminoplast crosslinkers and tin containing catalysts. Thus, the inventive coating compositions are especially suitable for OEM repair and refinish applications where low curing temperatures are used. By using a metal alkoxide C2 in combination with catalyst C1 of general formula (III), silane-based compound R1 and acid-functional polymer P1, the appearance, especially the short wave value, as well as the flexibility of the resulting clearcoat layer can be improved compared to clearcoat layers being prepared by using a combination of silane-based compound R1 and catalysts C1 and C2. Moreover, the addition of the acid-functional polymer P1 allows to significantly reduce the amount of expensive silane-based compound R1, thus lowering the overall material costs for the inventive coating composition.

A further subject of the present invention is a method for forming a coating on a substrate (S) comprising the following steps:
(1) applying an inventive coating composition on the substrate (S);
(2) forming a coating film from the coating composition applied in step (1); and
(3) curing the coating film formed in step (2).

Another subject of the present invention is a coated substrate obtained according to the inventive method.

Yet another subject of the present invention is a multilayer coating comprising at least two coating layers, preferably at least one basecoat and at least one clearcoat layer, wherein at least one of the coating layers, preferably the clearcoat layer, is formed from the inventive coating composition.

A final subject of the present invention is a substrate coated with an inventive multilayer coating.

### DETAILED DESCRIPTION

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

The term “silane-based compound” refers to compounds comprising at least one silane group of formula (I) or (II) described above. Said silane-group is attached via the * symbol to a skeleton of the compound preferably through an urea linkage. As used herein, the “skeleton” of the compound is the portion of the compound other than structure (I) and optionally (II). When a suitable skeleton of the compound is a polymer, the silane groups (I) and optionally (II) may be pendent from the polymer chain, or they may be incorporated into the polymer chain, or a combination thereof.

The term “poly(meth)acrylate” refers both to polyacrylates and to polymethacrylates. Poly(meth)acrylates may therefore be composed of acrylates and/or methacrylates and may comprise further ethylenically unsaturated monomers such as styrene or acrylic acid, for example.

The term “aliphatic” as used herein includes the term “cycloaliphatic” and refers to nonaromatic groups, moieties and compounds, respectively.

All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question.

### Inventive Coating Compositions

The inventive coating compositions each comprise at least one aprotic solvent and are therefore preferably solvent-based coating compositions. In the context of the present invention, a solvent-based coating composition preferably comprises a total amount of water and/or protic solvents of less than 10 wt.-%, preferably less than 5 wt.-%, more preferably less than 1 wt.-%, very preferably 0 wt.-%, based in each case on the total weight of the coating composition.

### Silane-Based Compound R1 (A)

The inventive coating composition comprises as first mandatory component (a) at least one silane-based compound R1 having an isocyanate content (also called NCO content hereinafter) of less than 1% and comprising at least one silane group of general formula (I)

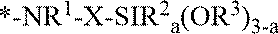

and optionally at least one silane group of general formula (II)

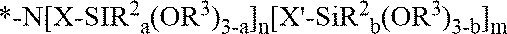

wherein R¹ to R³, X, X′, a, b, m and n are as previously defined. The silane groups of formulae (I) and (II) are bound via the *-symbol to the skeleton of the silane-based compound R1 as previously described. The silane-based compound R1 preferably comprises an isocyanate content of less than 0.5%, more preferably of 0.05 to 0%. This ensures that the silane-based compound R1 does only comprise a rather low amount of free NCO groups or is essentially free of NCO groups, thus allowing to use this compound in isocyanate-free coating compositions.

The reactivity of organofunctional silanes can be influenced considerably by the length of the spacers X, X′ between silane functionality and organic functional group serving for reaction with the skeleton of the silane-based compound R1. X and X′ in general formulae (I) and (II) preferably represent, independently from each other, a linear alkylene radical having 1 to 10, more preferably 1 to 6, even more preferably 2 to 5, very preferably 3, carbon atoms.

R¹ in general formula (I) is preferably an alkyl group containing 2 to 8 carbon atoms, more preferably 4 to 6 carbon atoms, very preferably 4 carbon atoms.

The respective preferred alkoxy radicals (OR³) influence the reactivity of the hydrolyzable silane groups. Particularly preferred are radicals R³ which raise the reactivity of the silane groups, i.e., which constitute good leaving groups. Thus, a methoxy radical is preferred over an ethoxy radical, which is preferred in turn over a propoxy radical. With particular preference, therefore, R³ in formulae (I) and (II) represent, independently from each other, a C₁-C₁₀ alkyl group, more preferably a C₁-C₆ alkyl group, very preferably a C₁ alkyl group.

The silane group of general formula (II) comprises two alkoxysilane moieties, thus the sum of n and m is 2. The respective alkoxysilane moieties can be the same or can differ from each other. In case of different alkoxysilane moieties, R³ and R⁴ are different if m = n = 1. In case of the same alkoxysilane moieties, either R³ and R⁴ are the same and m = n = 1 orm = 0 and n = 2 or vice versa.

Preferred silane groups of general formula (I) and, if present, silane groups of formula (II), each comprise three alkoxy moieties. Therefore, a in formulae (I) and (II) and b in formula (II) favorably are, independently from each other, 0.

The silane-based compounds R1 (a) can be prepared by reacting at least one polyisocyanate with at least one compound of general formula (la)

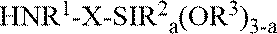

and optionally with at least one compound of general formula (IIa)

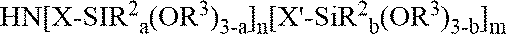

R¹ to R³, X, X′, a, b, m and n in general formulae (la) and (IIa) are as previously defined.

In principle, all aliphatic, cycloaliphatic, araliphatic and aromatic polyisocyanates can be used as polyisocyanates. Examples of polyisocyanates used preferably are as follows: 2,4-toluene diisocyanate, 2,6-toluene diisocyanate, diphenylmethane 4,4′-diisocyanate, diphenylmethane 2,4′-diisocyanate, p-phenylene diisocyanate, biphenyl diisocyanates, 3,3′-dimethyl-4,4′-diphenyl diisocyanate, tetramethylene 1,4-diisocyanate, hexamethylene 1,6-diisocyanate, 2,2,4-trimethylhexane 1,6-diisocyanate, isophorone diisocyanate, ethylene diisocyanate, 1,12-dodecane diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate hexahydrophenylene 1,3-diisocyanate, hexahydrophenylene 1,4-diisocyanate, perhydrodiphenylmethane 2,4′-diisocyanate, 4,4′-methylenedicyclohexyl diisocyanate (e.g., Desmodur® W from Covestro AG), tetramethylxylyl diisocyanates (e.g., TMXDI® from American Cyanamid), and mixtures of the aforementioned polyisocyanates. Further-preferred polyisocyanates are the polyisocyanates derived from a polyisocyanate by trimerization, dimerization, urethanization, biuretization or allophanatization. Polyisocyanates used with particular preference are hexamethylenediisocyanate uretdione, hexamethylenediisocyanate, 1-isocyanato-4-[(4-isocyanatocyclohexyl)-methyl]-cyclohexane and hexamethylene diisocyanate trimer.

Inventively preferred compounds (la) are aminoalkyltrialkoxysilanes, such as preferably 2-aminoethyltrimethoxysilane, 2-aminoethyltriethoxysilane, 3-aminopropyltrimethoxysilane, 3-aminopropyltriethoxysilane, 4-aminobutyltrimethoxysilane, 4-aminobutyltriethoxysilane. Particularly preferred compounds (la) are N-(2-(trimethoxysilyl)ethyl)alkylamines, N-(3-(trimethoxysilyl)propyl)alkylamines, N-(4-(trimethoxysilyl)butyl)alkylamines, N-(2-(triethoxysilyl)ethyl)alkylamines, N-(3-(triethoxysilyl)-propyl)alkylamines and/or N-(4-(triethoxysilyl)butyl)alkylamines. Particularly preferred amino silanes of formula (la) are alpha-amino silanes (X = CH₂) and gamma-amino silanes (X = n-propyl), the gamma-amino silanes being most preferred in the present invention. Particularly preferred are N-alkylamino-alkyl-trialkoxysilanes amongst which n-alkylamino-propyl trimethoxy silanes are most preferred such as n-butylamino-propyl-trimethoxysilane. Aminosilanes of this kind are available, for example, under the brand name DYNASYLAN® from DEGUSSA or Silquest® from Momentive.

Preferred compounds (IIa) are bis (2-ethyltrimethoxysilyl) amine, bis (3-propyltrimethoxysilyl) amine, bis (4-butyltrimethoxysilyl) amine, bis (2-ethyltriethoxysilyl) amine, bis (3-propyltriethoxysilyl) amine and / or bis (4-butyltriethoxysilyl) amine. Very particular preference is given to bis (3-propyltrimethoxysilyl) amine.

Preferred compounds (IIa) of this kind are available for example under the brand name DYNASILAN® from DEGUSSA or Silquest® from Momentive.

The reaction of the at least one polyisocyanate with compound of general formula (la) and optionally compound of general formula (IIa) can be carried out without solvent or in the presence of an aprotic solvent until essentially all, preferably all, free isocyanate groups of the at least one polyisocyanate are consumed. The reaction preferably takes place in inert gas at temperatures of not more than 100° C., preferably at not more than 60° C.

It is preferred according to the invention if the silane-based compound R1 contains 50 to 100 mol %, preferably 80 to 100 mol %, more preferably 95 to 100 mol %, of at least one silane group of general formula (I) and 0 to 50 mol %, preferably 0 to 20 mol %, more preferably 0 to 5 mol %, of at least one silane group of general formula (II), based in each case on the entirety of the silane groups of general formulae (I) and (II). It has been found that in particular the ratio of silane groups of general formula (I) to the silane groups of general formula (II) has a quite critical influence on the occurrence of cracks in the resultant coating. In this relationship, generally speaking, the occurrence of cracks in the resultant coatings increases with decreasing fraction of monosilane groups of general formula (I) and with increasing fraction of bissilane groups of general formula (II). Thus, particularly preferred silane-based compound R1 contain 100 mol-% of silane groups of general formula (I) and 0 mol-% of silane groups of general formula (II).

Very surprising, and also highly advantageous, is the fact that, simultaneously with the decrease of the occurrence of cracks through an increasing fraction of monosilane groups of general formula (I) and a decreasing fraction of bissilane groups of general formula (II), there is only a very slight deterioration in the scratch resistance of the resultant coating.

The silane-based compound R1 is preferably present in a total amount of 5 to 45 wt.-%, more preferred 10 to 40 wt.-% and most preferred from 12 to 35 wt.-%, based in each case on the total weight of the coating composition. This amount of silane-based compound R1, which is employed in the coating composition, is the calculated theoretical amount of the silane-based compound R1 based on the proviso that the sum of the weights of reactants employed in the production of silane-based compound R1 equals the final weight of the silane-based compound R1.

### Catalyst C1 of General Formula (III) (b)

The inventive coating composition comprises as second mandatory component (b) at least one catalyst C1 of general formula (III)

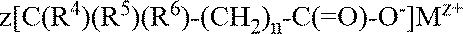

wherein
R⁴ to R⁶ are, independently from each other, hydrogen or alkyl groups containing 1 to 6 carbon atoms, with the proviso that the sum of the number of carbon atoms in residues R⁴ to R⁶ ranges from 3 to 8;
z being 1 to 4; and
n being 0 or 1 to 8 with the proviso that,
if z = 1, then M is selected from the group consisting of Li, K and Na;
if z = 2, then M is selected from the group consisting of Zn and Zr;
if z = 3, then M is selected from the group consisting of Bi and Al;
if z = 4, then M is selected from the group consisting of Zr and Ti.

The sum of the number of carbon atoms in residues R⁴ to R⁶ in general formula (III) is preferably from 3 to 5 or from 5 to 8.

z in general formula (III) is preferably 1, 3 or 4, more preferably 1 or 4.

n in general formula (III) is preferably 0 or 2 to 6, preferably 0 or 4. If n is 0, residues R⁴ and R⁵ in general formula (III) are, independently from each other, linear or branched C₃-C₅ alkyl groups and residue R⁶ is a methyl group, with the proviso that the sum of all carbon atoms of residues R⁴ to R⁶ is 8. If n in general formula (III) is 1 to 8, preferably 4, residues R⁴ to R⁶ are, independently from each other, methyl groups.

M in general formula (III) is preferably potassium, lithium or titanium, preferably potassium or titanium.

Particularly preferred catalysts C1 of general formula (III) are neodecanoates and/or ethylhexanoates of potassium, lithium or titanium, preferably potassium (I) neodecanoate, potassium (I) 2-ethylhexanoate, titanium (IV) neodecanoate or titanium (IV) 2-ethylhexanoate. Very preferably, exactly one catalyst C1, with particular preference potassium (I) neodecanoate, titanium (IV) neodecanoate or titanium (IV) 2-ethylhexanote, is contained in the inventive coating compositions. The use of potassium (I) neodecanoate is particularly preferred because the resulting coating layers show a significantly improved appearance.

Often, the catalysts C1 of formula (III) are supplied by manufacturers in acid stabilized form. It is preferred to use such acid-stabilized catalysts C1 of formula (III), not only because of their higher storage stability, but also because they introduce free acid into the coating composition according to the present invention. Such free acids are known to be beneficial in combination with the catalysts C2 and can, in addition, improve silane hydrolysis and consequently the network formation. The stabilizing acid is generally the protonated residue C(R⁴)(R⁵)(R⁶)—(CH₂)ₙ—C(═O)—OH contained in general formula (III). If the supply form of the catalyst C1 contains the stabilizing acid C(R⁴)(R⁵)(R⁶)—(CH₂)ₙ—C(═O)—OH, the content of this acid is subsumed under the carboxylic acids of formula (VI) as described later on.

The amount of the at least one catalyst C1, particularly potassium (I) neodecanoate or titanium (IV) neodecanoate, preferably ranges from 1 mmol to 50 mmol, more preferred from 5 mmol to 40 mmol and most preferred from 15 to 35 mmol metal, based in each case on 100 g silane-based compound R1 solid.

### Metal Alkoxide C2 (c)

The inventive coating composition comprises as third mandatory component (c) at least one metal alkoxide. Said metal alkoxide is used as co-catalyst and results - in combination with catalyst C1, preferably potassium (I) neodecanoate or titanium (IV) neodecanoate - in an improved resistance to humidity conditions as compared to compositions comprising nitrogen compounds, such as DBU, as co-catalyst. Without wishing to be bound to any specific theory, it is assumed that the metal alkoxide can participate in the condensation reaction of the silane-based compound R1 during curing.

The at least one metal alkoxide C2 is preferably selected from metal alkoxides of the general formula (IV)

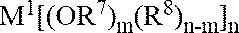

wherein
R⁷ is a linear or branched C₁ to C₁₀ alkyl group,
R⁸ is a halogen group, an acetylacetonate group, an alkyl acetoacetate group or an ethanolaminato group,
M¹ represents at least one metal selected from silicon, titanium, tantalum, zirconium, boron, aluminum, magnesium or zinc,
m is an integer from 0 to 4, and
n represents a valence of 2 to 5 of M¹.

R⁷ in general formula (IV) is preferably selected from a C₃ to C₅ alkyl group, more preferably from a C₃ or a C₄ alkyl group.

R⁸ in general formula (IV) is preferably an alkyl acetoacetate group, more preferably an ethyl acetoacetate group. m in general formula (IV) is preferably 0 or 1 to 4, more preferably 0 or 2 to 4, very preferably 0, 2 or 4.

M¹ in general formula (IV) is preferably a metal selected from titanium and n represents a valence of 4.

Particularly preferred catalysts C2 are selected from titanium (IV) isopropoxide and/or titanium (IV) n-butoxide and/or titanium (IV) bis(ethylacetoacetate)diisopropoxide, very preferably titanium (IV) isopropoxide.

The at least one metal alkoxide C2, preferably metal alkoxides of general formula (III), is preferably present in a total amount of 2.5 to 40 mmol metal, based in each case on 100 g silane-based compound R1 solid.

The metal to metal ratio of catalyst C1 of general formula (II) to the at least one metal alkoxide C2, preferably the metal alkoxide of general formula (III), is preferably from 1:2 to 2:1. Use of said catalyst mixture in the afore-stated ratios results in improved resistance to humidity conditions, thus significantly reducing the blistering and whitening of a cured coating layer obtained from the inventive coating composition after exposure to humidity conditions as compared to cured coating layers being prepared by using a nitrogen containing co-catalyst, for example DBU, instead of the metal alkoxide C2.

### Acid-Functional Polymer P1 (d)

As fourth mandatory component, the inventive coating composition comprises at least one polymer P1 having an acid number of more than 10 mg KOH/g solids (hereinafter denoted as acid-functional polymer P1).

Suitable polymers P1 are selected from homo- or copolymers of unsaturated acids, polyurethanes having at least one group being capable of forming anions, polyurethane (meth)acrylates having at least one group being capable of forming anions and mixtures thereof, preferably homo- or copolymers of unsaturated acids, very preferably homo- or copolymers of unsaturated carboxylic acids. The term “polymer having at least one group being capable of forming anions” refers to polymers having at least one group which can form anions under specific conditions, for example by reaction with a suitable neutralizing agent. The term “polymer” is well known to the person skilled in the art and refers to compounds produced by polymerizing the same or different types of monomers and includes homopolymers, copolymers, terpolymers and the like. The term “homopolymer” refers to polymers being prepared by polymerization of only one type of monomer while the term “copolymer” denotes polymers being prepared by polymerization of at least two different monomers.

Homo- or copolymers of unsaturated acids, preferably unsaturated carboxylic acids, can be prepared by known methods, such as bulk or solution polymerization. The polymerization can be carried out as a volatile radical polymerization. The free radicals are typically provided by a redox initiator or an organic peroxo or azo compound. Suitable initiators are selected from the group of ammonium peroxydisulfate, potassium peroxydisulfate, sodium metabisulfite, hydrogen peroxide, t-butyl hydroperoxide, dilauryl peroxide, t-butyl peroxybenzoate, t-butylper-2-ethylhexanoate, di-tert-butyl peroxide, 2,2′-azobitrile (isobutyronitrile) 2,2′-azobis (isovaleronitrile) and redox initiators such as ammonium peroxydisulfate and sodium metabisulfite with iron (II) ammonium sulfate. Furthermore, the polymerization can be carried out as anionic, cationic or controlled radical polymerization.

In this regard, suitable groups being capable of forming anions are selected from carboxylic acid groups, sulfonic acid groups, phosphonic acid groups and mixtures thereof, preferably carboxylic acid groups.

The polymer P1, favorable the group(s) being capable of forming anions of polymer P1, is preferably only partially neutralized or not neutralized at all. The degree of neutralization of polymer P1 is thus preferably 0 to 20 %, more preferably 0 to 10%, very preferably 0%. A degree of neutralization of 0% means that all acid functions of the polymer P1 are present in non-neutralized form in the coating composition, i.e. none of the acid functions of polymer P1 has been reacted with a neutralizing agent, for example a base. Without wishing to be bound to this theory, the presence of a sufficiently high amount of acid functions in the polymer P1 leads to the formation of a multifunctional hybrid matrix by silane-silane condensation, silane-titanium condensation and titanium-carboxylic acid complexation during curing of the coating composition. This results in improved appearance, especially short wave values, and flexibility of the cured coating layers obtained from the coating composition.

Preferred polymers P1 comprise - in polymerized form —
(i) at least one unsaturated monomer M1 having at least one group being capable of forming anions;
(ii) optionally at least one unsaturated monomer M2 selected from esters of (meth)acrylic acid having an alkyl radical substituted by at least one hydroxyl group;
(iii) optionally at least one lactone;
(iv) optionally at least one further unsaturated monomer M3 being different from monomers M1 and M2; and
(v) optionally at least one cyclic carboxylic acid anhydride.

The term “in polymerized form” in the sense of the present invention is understood to mean that compound (i) and optionally compounds (ii) to (v) are used as starting materials to prepare polymer P1, i.e. the polymer P1 comprises, preferably consists of, the reaction product of compound (i) and optionally compounds (ii) to (iv).

Suitable monomers M1 are selected from (meth)acrylic acid, ethacrylic acid, crotonic acid, maleic acid, fumaric acid and itaconic acid; olefinically unsaturated sulfonic and phosphonic acids and their partial esters; and mono(meth)acryloyloxyethyl maleate, mono(meth)acryloyloxyethyl succinate, and mono(meth)acryloyloxyethyl phthalate, preferably (meth)acrylic acid, very preferably acrylic acid.

The at least one monomer M1, particularly acrylic acid, is preferably present in a total amount of 1 to 100 wt.-%, preferably 5 to 50 wt.-%, more preferably 10 to 20 wt.-%, very preferably 12 to 17 wt.-%, based on the total amount of compounds (i) to (v). The total weight of monomer M1 is therefore based on the total amount of all monomers M1 to M3, lactone and cyclic carboxylic acid anhydride present in the polymer P1.

Apart from the at least one monomer M1, it is preferred if the polymer P1 comprises at least one unsaturated monomer M2 selected from esters of (meth)acrylic acid having an alkyl radical substituted by at least one hydroxyl group. Suitable monomers M2 are selected from 2-hydroxyethyl (meth)acrylate, 2-hydroxypropyl (meth)acrylate, 3-hydroxypropyl (meth)acrylate, 3-hydroxybutyl (meth)acrylate, 4-hydroxybutyl (meth)acrylate and mixtures thereof, very preferably 2-hydroxyethyl methacrylate.

The at least one monomer M2, particularly 2-hydroxyethyl methacrylate, is preferably present in a total amount of 1 to 30 wt.-%, preferably 5 to 25 wt.-%, more preferably 10 to 20 wt.-%, very preferably 12 to 15 wt.-%, based on the total amount of compounds (i) to (v).

With particular preference, the at least one polymer P1 comprises - apart from monomer M1 - at least one monomer M2 and at least one lactone. The use of said at least one lactone results in brush polymers having polylactone side chains and leads to an improved flexibility of the polymer.

Suitable lactones are compounds of general formula (V)

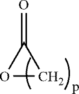

wherein p is an integer from 1 to 10, preferably 1 to 8, more preferably 3 to 6, very preferably 5. A particularly preferred lactone of general formula (V) is therefore epsilon-caprolactone.

The at least one lactone, particularly epsilon-caprolactone, is preferably present in a total amount of 0.5 to 25 wt.-%, preferably 1 to 20 wt.-%, more preferably 5 to 15 wt.—%, very preferably 5 to 11 wt.-%, based on the total amount of the compounds (i) to (v).

Preferably, the polymer P1 comprises - apart from monomers M1, M2 and lactone previously described - at least further one unsaturated monomer M3 being different from monomers M1 and M2. Suitable monomers M3 are selected from alkyl (meth)acrylates (M3-1) and/or unsaturated monomers comprising at last one aromatic moiety (M3-2).

In this regard, preferred alkyl (meth)acrylates (M3-1) are selected from methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, n-butylmethyl (meth)acrylate, ethylhexyl (meth)acrylate, 3,3,5-trimethylhexyl (meth)acrylate, stearyl (meth)acrylate, lauryl (meth)acrylate, cycloalkyl (meth)acrylates such as cyclopentyl (meth)acrylate, isobornyl (meth)acrylate, cyclohexyl (meth)acrylate and mixtures thereof, preferably n-butylmethyl acrylate and/or ethylhexyl acrylate.

Preferred unsaturated monomers comprising at least one aromatic group (M3-2) are selected from vinylaromatic compounds, such as styrene, α-methylstryrene, vinyltoluene, t-butylstryrene and mixtures thereof, preferably styrene.

If present, the polymer P1 may comprise the at least one further monomer M3 in a total amount of 1 to 75 wt.-%, preferably 5 to 70 wt.-%, more preferably 10 to 65 wt.-%, very preferably 50 to 60 wt.-%, based in each case on the total amount of the compounds (i) to (v). If more than one monomer M3 is used to prepare the polymer P1, the aforestated amounts relate to the total amount of all monomers M3 being present in the polymer P1.

Suitable amounts of alkyl (met)acrylates (M3-1), particularly n-butylmethyl acrylate and/or ethylhexyl acrylate, range from 10 to 60 wt.-%, preferably 30 to 55 wt.-%, more preferably 35 to 50 wt.-%, very preferably 37 to 46 wt.-%, based on the total amount of the compounds (i) to (v). Suitable amounts of unsaturated monomers comprising at least one aromatic group (M3-2), preferably styrene, range from 1 to 30 wt.-%, preferably 5 to 25 wt.-%, more preferably 10 to 20 wt.-%, very preferably 14 to 17 wt.-%, based in each case on the total amount of the compounds (i) to (v).

The polymer P1 preferably contains a weight ratio of the alkyl (meth)acrylate (M3-1) to the unsaturated monomer comprising at least one aromatic moiety (M3-2) of 5 : 1 to 1:1, more preferably 4 : 1 to 1 : 1, very preferably 3 : 1 to 2 : 1.

With particular preference, the polymer P1 comprises - in polymerized form - at least one cyclic carboxylic acid anhydride. The use of said anhydride results in an increased acid number of polymer P1. Higher acid numbers of the polymer P1 are favorable since an improved adhesion is obtained when using polymers P1 having higher acid numbers. Suitable cyclic carboxylic acid anhydrides are selected from aromatic and aliphatic carboxylic acid anhydrides, preferably aliphatic carboxylic acid anhydrides. With particular preference, hexahydrophthalic anhydride is used as cyclic carboxylic anhydride.

Preferably, the polymer P1 contains the at least one cyclic carboxylic anhydride, preferalby hexahydrophthalic anhydride, in a total amount of 1 to 30 wt.-%, more preferably 5 to 25 wt.-%, even more preferably 8 to 15 wt.-%, very preferably 5 to 11 wt.-%, based in each case on the total amount of compounds (i) to (v).

A particularly preferred polymer P1 therefore comprises - in polymerized form - and based on the total amount of compounds (i) to (vi):
(i) 5 to 50 wt.-%, preferably 12 to 15 wt.-%, of at least one unsaturated monomer M1 having at least one group being capable of forming anions, preferably acrylic acid;
(ii) 1 to 30 wt.-%, 12 to 14 wt.-%, at least one monomer M2 selected from esters of (meth)acrylic acid having an alkyl radical substituted by at least one hydroxyl group, preferably 2-hydroxyethyl methacrylate;
(iii) 0.5 to 25 wt.-%, preferably 5 to 11 wt.-%, of at last one lactone, preferably at least one lactone of general formula (V), very preferably epsilon-caprolactone;
(iv) 10 to 60 wt.-%, preferably 37 to 41 wt.-%, of at least one alkyl (meth)acrylate (M3-1), preferably n-butylmethyl acrylate and/or ethylhexyl acrylate;
(v) 1 to 30 wt.-%, preferably 14 to 16 wt.-%, of at least one unsaturated monomer comprising at least one aromatic group (M3-2), preferably styrene; and
(vi) 1 to 30 wt.-%, preferably 9 to 11 wt.-%, of at least one cyclic carboxylic acid anhydride, preferably hexahydrophthalic anhydride.

A further particularly preferred polymer P1 therefore comprises - in polymerized form
and based on the total amount of compounds (i) to (v):
   (i) 5 to 50 wt.-%, preferably 14 to 16 wt.-%, of at least one unsaturated monomer M1 having at least one group being capable of forming anions, preferably acrylic acid;
   (ii) 1 to 30 wt.-%, 13 to 15 wt.-%, at least one monomer M2 selected from esters of (meth)acrylic acid having an alkyl radical substituted by at least one hydroxyl group, preferably 2-hydroxyethyl methacrylate;
   (iii) 10 to 60 wt.-%, preferably 41 to 44 wt.-%, of at least one alkyl (meth)acrylate (M3-1), preferably n-butylmethyl acrylate and/or ethylhexyl acrylate;
   (iv) 1 to 30 wt.-%, preferably 15 to 17 wt.-%, of at least one unsaturated monomer comprising at least one aromatic group (M3-2), preferably styrene; and
   (v) 1 to 30 wt.-%, preferably 10 to 12 wt.-%, of at least one cyclic carboxylic acid anhydride, preferably hexahydrophthalic anhydride.

Said polymer P1 preferably has an acid number of 15 to 400 mg KOH/g solids, more preferably 30 to 300 mg KOH/g solids, even more preferably 60 to 200 mg KOH/g solids, very preferably 90 to 130 mg KOH/g solids, as determined according to DIN EN ISO 2114:2002-06 (procedure A).

The polymer P1 preferably has a weight average molecular weight M_{w} of 1,000 to 10,000 g/mol, more preferably 3,000 to 8,000 g/mol, even more preferably 4,000 to 6,000 g/mol, very preferably 4,800 to 5,400 g/mol. Moreover, the polymer P1 preferably has a number average molecular weight Mₙ of 450 to 4,000 g/mol, more preferably 500 to 3,000 g/mol, even more preferably 800 to 2,000 g/mol, very preferably 900 to 1,300 g/mol. The weight average and number average molecular weight can be determined by GPC using polystyrene as internal standard according to DIN 55672-1:2016-03.

The polydispersity D (M_{w}/Mₙ), of the polymer P1 is preferably in the range of 2.0 to 6.5, more preferably 3.0 to 6.0, very preferably 4.3 to 4.8

Polymers P1 used according to the invention can be prepared by polymerizing a mixture M comprising monomer M1 and optionally monomer M2, M3 and the lactone. Said polymer P1-1 can afterwards be reacted with the cyclic carboxylic acid anhydride to increase the acid number of obtained polymer P1.

Therefore, polymers P1 can be obtained by
(a) polymerizing a mixture M comprising:
   (i) at last one unsaturated monomer M1 having at least one group being capable of forming anions;
   (ii) optionally at least one unsaturated monomer M2 selected from esters of (meth)acrylic acid having an alkyl radical substituted by at least one hydroxyl group;
   (iii) optionally at least one further monomer M3 being different from monomers M1 and M2
   (iv) optionally at least one lactone; and
(b) optionally reacting the polymer obtained in step (a) with at least one cyclic carboxylic acid anhydride.

Suitable monomers M1 to M3, lactones and cyclic carboxylic acid anhydrides are the ones previously disclosed in connection with polymer P1.

The at least one unsaturated monomer M1 having at least one group being capable of forming anions, particularly acrylic acid, is preferably present in the mixture M in a total amount of 5 to 35% by weight, more preferably 7 to 30% by weight, even more preferably 10 to 25% by weight, very preferably 12 to 19% by weight, based on the total amount of mixture M.

The at least one monomer M2, particularly 2-hydroxyethyl methacrylate, is preferably present in the mixture M in a total amount of 5 to 30% by weight, more preferably 7 to 25% by weight, even more preferably 10 to 20% by weight, very preferably 12 to 18 % by weight, based on the total amount of mixture M.

The at least one further monomer M3 being different from monomers M1 and M2, particularly n-butylmethyl acrylate and/or ethylhexyl acrylate and/or styrene, is preferably present in the mixture M in a total amount of 40 to 80% by weight, more preferably 45 to 75% by weight, even more preferably 50 to 70% by weight, very preferably 57 to 65% by weight, based on the total amount of mixture M.

In this regard, it is preferred if the alkyl (meth)acrylate (M3-1), preferably n-butylmethyl acrylate and/or ethylhexyl acrylate, is present in the mixture M in a total amount of 25 to 65% by weight, more preferably 30 to 6 % by weight, even more preferably 35 to 55% by weight, very preferably 41 to 50% by weight, based in each case on the total amount of the mixture M.

In this regard, it is furthermore preferred, if the unsaturated monomer comprising at least one aromatic group (M3-2), preferably styrene, is present in the mixture M in a total amount of 1 to 40% by weight, more preferably 5 to 30% by weight, even more preferably 10 to 25% by weight, very preferably 15 to 20% by weight, based in each case on the total amount of the mixture M.

The at least one lactone, particularly epsilon-caprolactone, is preferably present in the mixture M in a total amount of 1 to 30% by weight, more preferably 3 to 25% by weight, even more preferably 4 to 20% by weight, very preferably 5 to 13% by weight, based on the total amount of mixture M.

Preferably, 1 to 30% by weight, more preferably 5 to 25% by weight, even more preferably 8 to 20% by weight, very preferably 10 to 15% by weight, based in each case on the total amount of mixture M, of cyclic carboxylic anhydride, preferably hexahydrophthalic anhydride, is reacted with the polymer obtained in step (a).

A particularly preferred polymer P1 is therefore obtained by:
(a) polymerizing a mixture M comprising - based on the total amount of the mixture M:
   (i) 5 to 35% by weight, preferably 12 to 17% by weight, of acrylic acid (monomer M1);
   (ii) 5 to 30% by weight, preferably 12 to 17% by weight, of 2-hydroxyethyl methacrylate (monomer M2);
   (iii) 25 to 65% by weight, preferably 41 to 47% by weight, of n-butylmethyl acrylate and/or ethylhexyl acrylate (monomers M3-1);
   (iv) 1 to 40% by weight, preferably 15 to 20% by weight, of styrene (monomer M3-2);
   (v) 1 to 30% by weight, preferably 5 to 15% by weight, of epsilon-caprolactone; and
(b) reacting the polymer obtained in step (a) with 1 to 30% by weight, preferably 10 to 15% by weight, based in each case on the total amount of mixture M, of hexahydrophthalic anhydride.

A further particularly preferred polymer P1 is therefore obtained by:
(a) polymerizing a mixture M comprising - based on the total amount of the mixture M:
   (i) 5 to 35% by weight, preferably 16 to 19% by weight, of acrylic acid (monomer M1);
   (ii) 5 to 30% by weight, preferably 15 to 18% by weight, of 2-hydroxyethyl methacrylate (monomer M2);
   (iii) 25 to 65% by weight, preferably 45 to 50% by weight, of n-butylmethyl acrylate and/or ethylhexyl acrylate (monomers M3-1);
   (iv) 1 to 40% by weight, preferably 15 to 20% by weight, of styrene (monomer M3-2);
(b) reacting the polymer obtained in step (a) with 1 to 30% by weight, preferably 10 to 15% by weight, based in each case on the total amount of mixture M, of hexahydrophthalic anhydride.

The at least one polymerP1 having an acid number of at least 10 mg KOH/g solids is preferably present in a total amount of 0.1 to 15 wt.-%, more preferred 0.5 to 10 wt.-% and most preferred from 1.5 to 8 wt.-%, based in each case on the total weight of the coating composition.

### Aprotic Solvent (e)

The inventive coating composition is a solvent-based coating composition and therefore comprises as fifth mandatory component (e) at least one aprotic solvent. The aprotic solvents in the coating composition are chemically inert toward the silane-based compound R1 and acid-functional polymer P1, i.e. they do not react with the silane-based compound R1 and acid-functional polymer P1 during storing and curing of the inventive coating composition.

Suitable aprotic solvents are selected from aliphatic and/or aromatic hydrocarbons, such as toluene, xylene, solvent naphtha, Solvesso 100 or Hydrosol® (from APAL), ketones, such as acetone, methyl ethyl ketone or methyl amyl ketone, esters, such as ethyl acetate, butyl acetate, pentyl acetate or ethyl ethoxypropionate, ethers, or mixtures of the afore-mentioned solvents. The aprotic solvents or solvent mixtures preferably have a water content of not more than 1% by weight, more preferably not more than 0.5% by weight, based on the solvent. However, some additives or catalysts used herein are sold in protic organic solvents, therefore, in some cases, it cannot be avoided to introduce some unwanted protic solvents, unless a solvent exchange is carried out before their use. If the amount of such protic solvents is kept in the above limits, such amounts can typically be neglected. If undesired premature crosslinking occurs due to the presence of protic solvents, e.g. introduced by additives, such additives are preferably introduced into the coating composition just prior to the application of the coating composition. Another possibility is to perform a solvent-exchange.

As previously mentioned, the inventive coating composition preferably comprises water and/or protic solvents in an amount of less than 10 wt.-%, preferably less than 5 wt.-%, more preferably less than 1 wt.-%, very preferably 0 wt.-%, based in each case on the total weight of the coating composition. Since the silane-based compound R1 is reacting with water and protic solvents, said solvents are preferably not present in order to maximize the pot life and storage stability of the inventive coating composition.

The aprotic solvents are typically introduced by using a solution or dispersion of the silane-based compound R1 and acid-functional polymer P1 in the aprotic solvent or mixtures of aprotic solvents. Further amounts are introduced to adjust the viscosity of the coating composition to a suitable application viscosity. The at least one aprotic solvent is preferably present in a total amount 1 to 70 wt.-%, more preferred 20 to 60 wt.-% and most preferred from 30 to 50 wt.-%, based in each case on the total weight of the coating composition.

### Further Optional Components of the Inventive Coating Compositions

### Carboxylic Acid of General Formula (VI)

The inventive coating compositions can further comprise at least one carboxylic acid of general formula (VI)

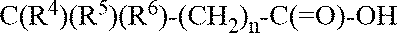

wherein
R⁴ to R⁶ are, independently from each other, hydrogen or alkyl groups containing 1 to 6 carbon atoms, with the proviso that the sum of the number of carbon atoms in residues R⁴ to R⁶ is from 3 to 8, preferably 5 to 8; and
n is 0 or 1 to 8, preferably 0 or 4.

Particularly preferred carboxylic acids of general formula (VI) are the free carboxylic acids which corresponds to the carboxylate anion of the catalyst of general formula (III). The carboxylic acid of general formula (VI) is introduced into the inventive coating composition by using catalysts C1 previously described which are stabilized by said carboxylic acid.

A particularly preferred carboxylic acid of general formula (VI) is neodecanoic acid.

The at least one carboxylic acid of general formula (VI), preferably neodecanoic acid, is preferably present in a total amount of 0 to 80 wt.-%, more preferably 30 to 70 wt.-%, very preferably 50 to 60 wt.-%, based in each case on the total amount of catalyst C1 of general formula (III).

### Epoxy Functional Compound of General Formula (VII)

The inventive coating compositions can further comprise at least one epoxy functional compound of general formula (VII)

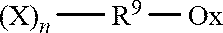

wherein
Ox is an oxirane group;
R⁹ is an aliphatic hydrocarbyl group containing 2 to 15 carbon atoms and optionally comprising ether groups and/or ester groups;
n is 1 to 5; and
X are, independently of each other, Ox or a *-Si(R^{g})₃₋ᵥ(R^{h})ᵥ group where v is 0 or 1, R^{g} is an alkoxy group containing 1 to 4 carbon atoms and R^{h} is an alkyl group containing 1 to 4 carbon atoms or an alkoxy group containing 1 to 4 carbon atoms.

R⁹ general formula (VII) is preferably an aliphatic hydrocarbyl group *—(CH₂)₃—O—CH₂—^{#} or a cyclohexyl ethyl group. The symbol * denotes the connection of the aliphatic hydrocarbyl group *—(CH₂)₃—O—CH₂—^{#} to the X residue(s), while the symbol # denotes the connection of the hydrocarbyl group *—(CH₂)₃—O—CH₂—^{#} to the oxirane group. The structure of the epoxy functional compound of general formula (VII) resulting from R⁹ being an aliphatic hydrocarbyl group *—(CH₂)₃—O—CH₂—^{#} is therefore (X)ₙ—(CH₂)₃—O—CH₂—Ox.

n general formula (VII) is preferably 1.

In case the X groups are oxirane groups, the compounds of general formula (VII) are aliphatic diglycidyl ethers, aliphatic polyglycidyl ethers, aliphatic diglycidyl esters and/or aliphatic polygylcidyl esters.

Examples of aliphatic di- or polyglycidyl ethers are 1,4-butanediol-diglycidylether (Heloxy 67), 1,6-hexanediol-diglycidylether (Heloxy modifier HD), trimethylolpropane triglycidylether (Heloxy 48), and neopentylglycol diglycidylether (Heloxy 68), hydrogenated bisphenol A diglycidyl ethers (for example sold under the trade name Epalloy 5000 and Epalloy 5001 from CVC Specialty Chemicals; or YX8000 from Japanese Epoxy Resins Co. Ltd.), cyclohexanedimethylol diglycidylether (for example sold under the trade name Heloxy 107 from Hexion), tricyclodecane dimethanol diglycidylether (for example sold under the trade name EP4088S from Adeka), compound synthesized from 2,2-bis(hydroxymethyl)-1,3-propanediol and 2-(chloromethyl)oxirane (Basocoll OV) or glycerol diglycidylether.

Examples of aliphatic di- or polyglycidyl esters include glycidyl ester of linoleic acid dimer (for example sold under the trade name Erisys GS-120 from CVC Specialty Chemicals), dimer acid diglycidyl ester (for example sold under the trade name Heloxy Modifier 71 from Hexion), and diglycidyl 1,2-cyclohexanedicarboxylate (for example sold under the trade name Epalloy 5200 from CVC Specialty Chemicals).

In case at least one of the X groups is a —Si(R^{g})₃₋ᵥ(R^{h})ᵥ group, the compounds of general formula (VII) are epoxy silanes. According to a preferred embodiment of the inventive coating composition, epoxy functional compounds of general formula (VII) are epoxy silanes. X general formula (VI) is therefore preferably a *—Si(R^{g})₃₋ᵥ(R^{h})ᵥ group where v is 0 or 1, R^{g} is an alkoxy group containing 1 to 4 carbon atoms and R^{h} is an alkoxy group containing 1 carbon atom or an alkyl group containing 1 carbon atom.

Particularly preferred epoxy compounds of general formula (VII) are selected from (3-glycidoxypropyl) trimethoxysilane, dimethoxy(3-glycidyloxypropyl)methylsilane, 2-(3,4-epoxycyclohexyl)ethyltrimethoxysilane, trimethylolpropane triglycidylether and reaction products of 2,2-bis(hydroxymethyl)-1,3-propanediol and 2-(chloromethyl)oxirane very preferably (3-glycidoxypropyl) trimethoxysilane, trimethylolpropane triglycidylether and reaction products of 2,2-bis(hydroxymethyl)-1,3-propanediol and 2-(chloromethyl)oxirane.

The at least one epoxy functional compound of general formula (VII) is preferably present in a total amount of 0 to 20 wt.-%, more preferred 2.5 to 15 wt.-% and most preferred from 5 to 10 wt.-%, based in each case on solids content of the coating composition.

### Further Additives

The coating compositions of the invention may further comprise at least one customary and known coatings additive in typical amounts, i.e., in amounts preferably from 0 to 20 wt.-%, more preferably from 0.005 to 15 wt.-% and particularly from 0.01 to 10 wt.-%, based in each case on the total weight of the coating composition. The before-mentioned weight-percentage ranges apply for the sum of all additives likewise.

Examples of suitable coating additives are (i) UV absorbers; (ii) light stabilizers such as HALS compounds, benzotriazoles or oxalanilides; (iii) rheology modifiers such as sagging control agents (urea crystal modified resins), organic thickeners and inorganic thickeners; (iv) free-radical scavengers; (v) slip additives; (vi) polymerization inhibitors; (vii) defoamers; (viii) wetting agents; (ix) fluorine compounds; (x) adhesion promoters; (xi) leveling agents; (xii) film-forming auxiliaries such as cellulose derivatives; (xiii) fillers, such as nanoparticles based on silica, alumina or zirconium oxide; (xiv) flame retardants; and (xv) mixtures thereof.

Amongst the above additives, the most preferred additives are UV absorbers being preferably present in an amount from 40.25 to 2.5 wt.-%, light stabilizers being preferably present in an amount from 40.25 to 2.5 wt.-% and leveling agents being preferably present in an amount from 0.005 to 2.5 wt.-%, the ranges being based on the total weight of the coating composition.

It is possible, but not desired, that the coating composition contains at least one further binder which is different from the silane-based compound R1, the acid-functional polymer P1 and the epoxy-functional compound of formula (VII). A “binder” in the context of the present invention and in accordance with DIN EN ISO 4618:2007-03 is the nonvolatile component of a coating composition, without pigments and fillers. Hereinafter, however, the expression is used principally in relation to particular physically curable polymers which optionally may also be thermally curable, examples being polyurethanes, polyesters, polyethers, polyureas, polyacrylates, polysiloxanes and/or copolymers of the stated polymers. A copolymer in the context of the present invention refers to polymer particles formed from different polymers. This explicitly includes both polymers bonded covalently to one another and those in which the different polymers are bound to one another by adhesion. Combinations of the two types of bonding are also covered by this definition.

However, such binders, if present at all, are contained in the coating composition according to the present invention in amounts of preferably less than 10 wt.-% and more preferred less than 5 wt.-%, based on the total weight of the coating composition. Most preferred coating compositions of the present invention are free from at least one further binder, especially hydroxy-functional polysiloxanes and/or alkoxy-functional polysiloxanes and/or hydroxy-functional poly (meth)acrylates, i.e. said further binder is present in an amount of 0 wt.-%, based on the total weight of the coating composition. The presence of hydroxy-functional poly(meth) acrylates results in reduced adhesion, especially steam jet adhesion, and appearance, especially short wave appearance and appearance after exposure to humidity conditions and is therefore not desired within the present invention.

The additives can comprise further catalysts C3 being different from catalysts C1 and C2 previously described. Suitable further catalysts C3 are, for example, bicyclic tertiary amines. Most preferred bicyclic tertiary amines are 1,5-diaza-bicyclo[4.3.0]non-5-ene (hereinafter referred to as DBN), 1,5-diaza-bicyclo(4,4,0)decene-5 (hereinafter referred to as DBD) or 1,8-diaza-bicyclo[5.4.0]undec-7-ene (herein referred to as DBU) and 1,4-diazabicyclo[2.2.2]octane (herein referred to as DABCO). Among them, DBU and DBN are preferred. Particularly preferred is DBU. Such bicyclic tertiary amines may be used alone, or two or more of them may be used in combination.

If said further catalyst, preferably DBU, is present, the weight ratio of catalyst C1 to the further catalyst C3 is preferably from 1:1 to 8:1, more preferred from 2:1 to 6:1 and most preferred from 3:1 to 5:1 such as 4:1.

The inventive coating compositions can be formulated as tinted clearcoat composition which, when applied to a substrate, are neither completely transparent and colorless as a clear coating nor completely opaque as a typical pigmented coating. A tinted clear coating is therefore transparent and colored or semi-transparent and colored. The color can be achieved by adding at least one pigment commonly used in coating compositions. Suitable pigments are, for example, organic and inorganic coloring pigments, effect pigments and mixtures thereof. Such color pigments and effect pigments are known to those skilled in the art and are described, for example, in Römpp-Lexikon Lacke und Druckfarben, Georg Thieme Verlag, Stuttgart, New York, 1998, pages 176 and 451. The terms “coloring pigment” and “color pigment” are interchangeable, just like the terms “visual effect pigment” and “effect pigment”. Suitable inorganic coloring pigments are selected from (i) white pigments, such as titanium dioxide, zinc white, colored zinc oxide, zinc sulfide, lithopone; (ii) black pigments, such as iron oxide black, iron manganese black, spinel black, carbon black; (iii) color pigments, such as ultramarine green, ultramarine blue, manganese blue, ultramarine violet, manganese violet, iron oxide red, molybdate red, ultramarine red, iron oxide brown, mixed brown, spinel and corundum phases, iron oxide yellow, bismuth vanadate; (iv) filer pigments, such as silicon dioxide, quartz flour, aluminum oxide, aluminum hydroxide, natural mica, natural and precipitated chalk, barium sulphate and (vi) mixtures thereof.

Suitable organic coloring pigments are selected from (i) monoazo pigments such as C.I. Pigment Brown 25, C.I. Pigment Orange 5, 36 and 67, C.I. Pigment Orange 5, 36 and 67, C.I. Pigment Red 3, 48:2, 48:3, 48:4, 52:2, 63, 112 and 170 and C.I. Pigment Yellow 3, 74, 151 and 183; (ii) diazo pigments such as C.I. Pigment Red 144, 166, 214 and 242, C.I. Pigment Red 144, 166, 214 and 242 and C.I. Pigment Yellow 83; (iii) anthraquinone pigments such as C.I. Pigment Yellow 147 and 177 and C.I. Pigment Violet 31; (iv) benzimidazole pigments such as C.I. Pigment Orange 64; (v) quinacridone pigments such as C.I. Pigment Orange 48 and 49, C.I. Pigment Red 122, 202 and 206 and C.I. Pigment Violet 19; (vi) quinophthalone pigments such as C.I. Pigment Yellow 138; (vii) diketopyrrolopyrrole pigments such as C.I. Pigment Orange 71 and 73 and C.I. Pigment Red, 254, 255, 264 and 270; (viii) dioxazine pigments such as C.I. Pigment Violet 23 and 37; (ix) indanthrone pigments such as C.I. Pigment Blue 60; (x) isoindoline pigments such as C.I. Pigment Yellow 139 and 185; (xi) isoindolinone pigments such as C.I. Pigment Orange 61 and C.I. Pigment Yellow 109 and 110; (xii) metal complex pigments such as C.I. Pigment Yellow 153; (xiii) perinone pigments such as C.I. Pigment Orange 43; (xiv) perylene pigments such as C.I. Pigment Black 32, C.I. Pigment Red 149, 178 and 179 and C.I. Pigment Violet 29; (xv) phthalocyanine pigments such as C.I. Pigment Violet 29, C.I. Pigment Blue 15, 15:1, 15:2, 15:3, 15:4, 15:6 and 16 and C.I. Pigment Green 7 and 36; (xvi) aniline black such as C.I. Pigment Black 1; (xvii) azomethine pigments; and (xviii) mixtures thereof.

Suitable effect pigments are selected from the group consisting of (i) plate-like metallic effect pigments such as plate-like aluminum pigments, gold bronzes, fire-colored bronzes, iron oxide-aluminum pigments; (ii) pearlescent pigments, such as metal oxide mica pigments; (iii) plate-like graphite pigments; (iv) plate-like iron oxide pigments; (v) multi-layer effect pigments from PVD films; (vi) liquid crystal polymer pigments; and (vii) mixtures thereof.

Tinted coating compositions preferably comprises the at least one color and/or effect pigment in a total amount of 0.1 to 10 wt.-%, preferably 1 to 4 wt.-%, based on the total weight of the coating composition.

If the inventive coating compositions are formulated as clearcoat compositions, they preferably do not comprise any coloring and/or effect pigments, i.e. the amount of coloring and/or effect pigments is preferably 0 wt.-%, based on the total weight of the coating composition. However, it is likewise possible to add filler materials and matting agents in order to adjust the gloss of the clearcoat materials.

The coating compositions of the invention preferably only contain a rather small amount of crosslinking agents and are very preferably free of any crosslinking agent customarily used in coating compositions. Thus, the coating compositions preferably comprise a total amount of less than 2 wt.-%, more preferably 0 wt.-%, based on the total weight of the coating composition, of at least one crosslinking agent and/or tin containing compound.

Said crosslinking agents which are preferably only contained in small quantities or are not present at all in the coating compositions are amino resins, polyisocyanates, blocked polyisocyanates, polycarbodiimides, photoinitiators, and mixtures thereof. Tin containing compounds which are preferably not contained are tin catalysts. The combination of the silane-based compound R1 with the mixture of catalysts C1 and C2 and the acid-functional polymer P1 results in sufficient crosslinking at low curing temperatures without the use of polyisocyanates or melamine resins and tin containing compounds which are undesirable from an ecological standpoint.

The inventive coating compositions can be one-component or a two-component coating composition. If the inventive coating compositions are formulated as one-component composition, traces of water need to be excluded in order to avoid crosslinking reactions during storage of said coating compositions. Preferably, the inventive coating compositions are formulated as two-component coating compositions. Said two-component coating compositions preferably comprise the silane-based compound R1— optionally diluted with an aprotic solvent - and, if present, optional epoxy functional compound of general formula (VII) in a first container and catalystC1, catalyst C2, acid-functional polymer P1, the optional at least one coating additive and the at least aprotic solvent in a second container. The components of containers 1 and 2 are then mixed prior to use, preferably shortly before application of the mixed coating composition to the substrate. The formulation of the inventive coating compositions as two-component composition result in higher storage stability because it is not necessary to exclude trace amounts of water.

### Inventive Method

The present invention is also directed to a method of coating a substrate with the inventive coating compositions in which the inventive coating compositions are applied on the substrate, a coating film is formed and said coating film is afterwards cured.

According to a first alternative, the substrate (S) is preferably selected from metallic substrates, metallic substrates coated with a cured electrocoat and/or a cured filler, plastic substrates and substrates comprising metallic and plastic components, especially preferably from metallic substrates. In case of metallic and plastic substrates or substrates comprising metallic and plastic components, said substrates may be pretreated before step (1) of the inventive process in any conventional way - that is, for example, cleaned (for example mechanically and/or chemically) and/or provided with known conversion coatings (for example by phosphating and/or chromating) or surface activating pre-treatments (for example by flame treatment, plasma treatment and corona discharge coming).

In this respect, preferred metallic substrates (S) are selected from iron, aluminum, copper, zinc, magnesium and alloys thereof as well as steel. Preferred substrates are those of iron and steel, examples being typical iron and steel substrates as used in the automobile industry sector. The substrates themselves may be of whatever shape -that is, they may be, for example, simple metal panels or else complex components such as, in particular, automobile bodies and parts thereof.

Preferred plastic substrates (S) are basically substrates comprising or consisting of (i) polar plastics, such as polycarbonate, polyamide, polystyrene, styrene copolymers, polyesters, polyphenylene oxides and blends of these plastics, (ii) synthetic resins such as polyurethane RIM, SMC, BMC and (iii) polyolefin substrates of the polyethylene and polypropylene type with a high rubber content, such as PP-EPDM, and surface-activated polyolefin substrates. The plastics may furthermore be fiber-reinforced, in particular using carbon fibers and/or metal fibers.

As substrates (S) it is also possible, moreover, to use those which contain both metallic and plastics fractions. Substrates of this kind are, for example, vehicle bodies containing plastics parts.

Metallic substrates comprising a cured electrocoating can be obtained by electrophoretically applying an electrocoat material on the metallic substrate (S) and curing said applied material at a temperature of 100 to 250° C., preferably 140 to 220° C. for a period of 5 to 60 minutes, preferably 10 to 45 minutes. Before curing, said material can be flashed off, for example, at 15 to 35° C. for a period of, for example, 0.5 to 30 minutes and/or intermediately dried at a temperature of preferably 40 to 90° C. for a period of, for example, 1 to 60 minutes. Suitable electrocoat materials and also their curing are described in WO 2017/088988 A1, and comprise hydroxy-functional polyether amines as binder and blocked polyisocyanates as crosslinking agent. Before application of the electrocoating material, a conversion coating, such as a zinc phosphate coat, can be applied to the metallic substrate. The film thickness of the cured electrocoat is, for example, 10 to 40 micrometers, preferably 15 to 25 micrometers.

Metallic substrates comprising a cured electrocoating and/or a cured filler can be obtained by applying a filler composition to a metallic substrate (S) optionally comprising a cured electrocoating or to a metallic and/or plastic substrate (S) and curing said filler composition at a temperature of 40 to 100° C., preferably 60 to 80° C. for a period of 5 to 60 minutes, preferably 3 to 8 minutes. Suitable filler compositions are well known to the person skilled in the art and are, for example, commercially available under the brand name Glasurit from BASF Coatings GmbH. The film thickness of the cured filler is, for example, 30 to 100 micrometers, preferably 50 to 70 micrometers.

According to a second alternative, the substrate in step (1) is a multilayer coating possessing defect sites. This substrate which possesses defect sites is therefore an original finish (i.e. multilayer coating), which is to be repaired or completely recoated. The above-described defect sites in the multilayer coating can be repaired means of the above-described process the invention. For this purpose, the surface to be repaired in the multilayer coating may initially be abraded. The abrading is preferably performed by partially sanding, or sanding off, either the basecoat and the clearcoat layer or all coating layers. Abrading only the basecoat and the clearcoat layer has become established especially in the OEM automotive refinishing segment, where, in contrast to refinishing in a workshop, generally speaking, defects occur only in the basecoat and/or clearcoat region, but do not, in particular, occur in the region of the underlying filler layer. If defects are also encountered in the filler layer, for example scratches which are produced, for example, by mechanical effects and which often extend down to the substrate surface (metallic or plastic substrate), abrading of all coating layers present on the substrate is necessary.

### Step 1

In step (1) of the inventive method, the inventive coating compositions are applied on the substrate (S). The application of said coating composition to the substrate (S) is understood as follows. The coating composition in question is applied such that the coating film produced in step (2) is disposed on the substrate, but need not necessarily be in direct contact with the substrate. For example, between the coating film and the substrate, there may be other coats disposed. Preferably, the coating composition is applied directly to the substrate (S) in step (1), meaning that the coating film produced in step (2) is in direct contact with the substrate (S).

The inventive coating compositions may be applied by the methods known to the skilled person for applying liquid coating materials, as for example by dipping, knifecoating, spraying, rolling, or the like. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference the coating composition is applied via pneumatic spray application or electrostatic spray application.

### Step 2

In step (2) of the inventive method, a coating film is formed from the coating composition applied in step (1). The formation of a film from the applied coating composition can be effected, for example, by flashing off the applied coating composition. The term “flashing off” is understood in principle as a designation for the passive or active evaporation of solvents from the coating composition, usually at ambient temperature (that is, room temperature). Since the coating material is still fluid directly after application and at the beginning of flashing, it may undergo flow to form a homogeneous, smooth coating film. Thus, after the flashing phase, a comparatively smooth coating film, which comprises less solvent in comparison with the applied coating composition is obtained. While the film is no longer flowable it is, for example, still soft. In particular, the coating film is not yet cured as described later on below.

The formation of the coating film in step (2) is performed at a temperature of 20 to 60° C. for a duration of 5 to 80 minutes, preferably performed at a temperature of 20 to 35° C. for a duration of 5 minutes to 70 minutes.

### Step 3

In step (3) of the inventive method, the coating film is cured. The curing of a coating film or composition is understood accordingly to be the conversion of such a film or composition into the service-ready state, in other words into a state in which the substrate furnished with the coating film in question can be transported, stored, and used in its intended manner. A cured coating film, then, is in particular no longer soft, but instead is conditioned as a solid coating film which, even on further exposure to curing conditions as described later on below, no longer exhibits any substantial change in its properties such as hardness or adhesion to the substrate.

In principle the curing is carried out at temperatures of 10 to 180° C., for example, in particular 40 to 90° C., for a duration of 5 to 80 minutes, preferably 10 to 50 minutes. Since the inventive method is especially suitable for refinish applications in which low-curing conditions are necessary, the curing in step (3) is preferably performed at a temperature of 20 to 30° C. for a duration of 10 to 70 minutes, preferably 20 to 60 minutes.

Typically layer thicknesses obtained after step (3) range from 15 µm to 80 µm, preferably 20 µm to 70 µm or 30 µm to 65 µm such as 40 µm to 60 µm.

The coating layers produced from the inventive coating compositions have an improved appearance, especially short wave values, and flexibility when compared to coating compositions not comprising an acid-functional polymer P1 or comprising a hydroxy-functional polymer. Moreover, curing of said coating compositions can be performed at low temperatures so that the inventive method is especially suitable for refinish applications. The cured coatings show good adhesion, fast sandability and polishability, a good appearance, stone chipping resistance and humidity resistance as well as a high scratch and solvent resistance. Additionally, thick coating layers can be produced without the occurrence of incidents or stress. Due to the absence of commonly used isocyanate and melamine crosslinking agents as well as tin catalysts, the inventive process has a good ecologic profile and can also fulfill strict environmental regulations.

What has been said about the inventive coating composition applies mutatis mutandis with respect to further preferred embodiments of the inventive method to prepare a coated substrate.

### Inventive Coated Substrate

The result after the end of step (3) of the method of the invention is a coated substrate of the invention.

Depending on the substrate material chosen, the coating compositions can be applied in a wide variety of different application areas. Many kinds of substrates can be coated. The coating compositions of the invention are therefore outstandingly suitable for use as decorative and protective coating systems, particularly for bodies of means of transport (especially motor vehicles, such as motorcycles, buses, trucks or automobiles) or parts thereof. The substrates preferably comprise a multilayer coating as used in automotive coating.

The coating compositions of the invention are also suitable for use on constructions, interior and exterior; on furniture, windows and doors; on plastics moldings, especially CDs and windows; on small industrial parts, on coils, containers, and packaging; on white goods; on sheets; on optical, electrical and mechanical components, and on hollow glassware and articles of everyday use.

What has been said about the inventive coating composition and the inventive method applies mutatis mutandis with respect to further preferred embodiments of the coated substrate according to the invention.

### Inventive Multilayer Coating

Yet another object of the present invention is a multilayer coating consisting of at least two coating layers, at least one of which is formed from a coating composition according to the present invention

Typically, the multilayer coating comprises at least two coating layers.

A preferred multilayer coating comprises at least a basecoat layer and a clearcoat layer. The coating compositions of the present invention preferably forms the clearcoat layer.

Even more preferred is a multilayer coating comprising at least one filler coat layer, coated with at least one basecoat layer, which again is coated with at least one clearcoat layer, the clearcoat layer preferably being formed from the coating compositions of the present invention.

Particularly, but not limited to automotive coating a multilayer coating preferably comprises an electrocoat layer, at least one filler coat layer on top of the electrocoat layer, at least one basecoat layer on top of the electrocoat layer and at least one clearcoat layer on top of the basecoat layer, the clearcoat layer preferably being formed from the coating compositions of the present invention.

Said multilayer coatings can be prepared as previously described in connection with the method of the invention. The applied coating layers can either be cured separately or at least two coating layers can be cured simultaneously. With particular preference, the at least one basecoat layer and the clearcoat layer are cured simultaneously. Application, drying or flash off and curing of the coating layers of the multilayer coating can be performed according to methods well known in the state of the art. Suitable electrocoating, filler and basecoat compositions are, for example, commercially available. Suitable substrates have already been previously mentioned in connection with the inventive method.

What has been said about the inventive coating composition, the inventive method and the coated substrate according to the invention applies mutatis mutandis with respect to further preferred embodiments of the inventive multilayer coating.

### Substrate Coated With Multilayer Coating

A final subject of the present invention is a substrate coated with a multilayer coating previously described.

What has been said about the inventive coating composition, the inventive method, the coated substrate according to the invention and the inventive multilayer coating applies mutatis mutandis with respect to further preferred embodiments of the inventive substrate coated with a multilayer coating.

The invention is described in particular by the following embodiments:

Embodiment 1: coating composition comprising:
a) at least one silane-based compound R1 having an isocyanate content of less than 1% and comprising at least one silane group of general formula (I)

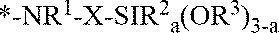

and optionally at least one silane group of general formula (II)

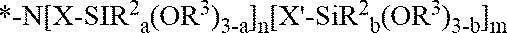

wherein
   X, X′ are, independently from each other, linear and/or branched alkylene or cycloalkylene radicals having 1 to 20 carbon atoms;
   R¹ is an alkyl group containing 1 to 10 carbon atoms,
   R^{2,} R³ are, independently from each other, alkyl, cycloalkyl, aryl, or aralkyl groups, it being possible for the carbon chain of the alkyl, cycloalkyl, aryl, or aralkyl groups to be interrupted by nonadjacent oxygen, sulfur or NRa groups, where Rₐ is alkyl, cycloalkyl, aryl, or aralkyl,
   m, n being, independently from each other, 0 to 2, with the proviso that m+n = 2, and
   a, b being, independently from each other, 0 to 2;
b) at least one catalyst C1 of general formula (III)

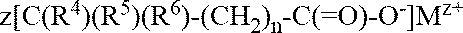

wherein
   R⁴ to R⁶ are, independently from each other, hydrogen or alkyl groups containing 1 to 6 carbon atoms, with the proviso that the sum of the number of carbon atoms in residues R⁴ to R⁶ ranges from 3 to 8;
   z being 1 to 4; and
   n being 0 or 1 to 8 with the proviso that,
   if z = 1, then M is selected from the group consisting of Li, K and Na;
   if z = 2, then M is selected from the group consisting of Zn and Zr;
   if z = 3, then M is selected from the group consisting of Bi and Al;
   if z = 4, then M is selected from the group consisting of Zr and Ti;
c) at least one metal alkoxide C2;
d) at least one polymer P1 having an acid number of more than 10 mg KOH/g solids, as determined according to DIN EN ISO 2114:2002-06 (procedure A); and
e) one or more aprotic organic solvents.

Embodiment 2: coating composition according to embodiment 1, characterized in that the silane-based compound R1 has an isocyanate content of less than 0.5 %, preferably of 0.05 to 0 %.

Embodiment 3: coating composition according to embodiment 1 or 2, characterized in that X and X′ in formulae (I) and (II) represent, independently from each other, a linear alkylene radical having 1 to 10, preferably 1 to 6, more preferably 2 to 5, very preferably 3, carbon atoms.

Embodiment 4: coating composition according to any of the preceding embodiments, characterized in that R¹ in general formulae (I) is an alkyl group containing 2 to 8 carbon atoms, preferably 4 to 6 carbon atoms, very preferably 4 carbon atoms.

Embodiment 5: coating composition according to any of the preceding embodiments, characterized in that R² in general formulae (I) and (II) represent, independently from each other, a C₁-C₁₀ alkyl group, preferably a C₁-C₆ alkyl group, very preferably a C₁ alkyl group.

Embodiment 6: coating composition according to any of the preceding embodiments, characterized in that a in general formulae (I) and (II) and b in general formula (II) are, independently from each other, 0.

Embodiment 7: coating composition according to any of the preceding embodiments, characterized in that the silane-based compound R1 contains 50 to 100 mol %, preferably 80 to 100 mol %, more preferably 95 to 100 mol %, of at least one silane group of general formula (I) and 0 to 50 mol %, preferably 0 to 20 mol %, more preferably 0 to 5 mol %, of at least one silane group of general formula (II), based in each case on the entirety of the silane groups of general formulae (I) and (II).

Embodiment 8: coating composition according to any of the preceding embodiments, characterized in that the silane-based compound R1 is prepared by reacting at least one polyisocyanate with at least one compound of general formula (la)

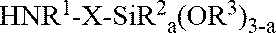

and optionally with at least one compound of general formula (IIa)

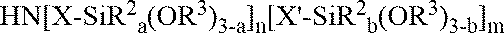

wherein
X, X′ are, independently from each other, linear and/or branched alkylene or cycloalkylene radicals having 1 to 20 carbon atoms, preferably a linear alkylene having 3 carbon atoms,
R¹ is an alkyl group containing 1 to 10 carbon atoms, preferably a linear alkyl group containing 4 carbon atoms
R², R³ are, independently from each other, alkyl, cycloalkyl, aryl, or aralkyl groups, it being possible for the carbon chain of the alkyl, cycloalkyl, aryl, or aralkyl groups to be interrupted by nonadjacent oxygen, sulfur or NRₐ groups, where Rₐ is alkyl, cycloalkyl, aryl, or aralkyl, preferably a C₁ alkyl group,
n, m being, independently from each other, 0 to 2, with the proviso that m+n = 2
a, b being, independently from each other, 0 to 2, preferably 0.

Embodiment 9: coating composition according to embodiment 8, characterized in that the at least one polyisocyanate has an average isocyanate functionality of 2 to 6, preferably of 2 to 5, very preferably of 2 to 3.5.

Embodiment 10: coating composition according to embodiment 8 or 9, characterized in that the polyisocyanate is selected from hexamethylenediisocyanate uretdione, hexamethylenediisocyanate, 1-Isocyanato-4-[(4-isocyanatocyclohexyl)methyl]-cyclohexane and hexamethylene diisocyanate trimer.

Embodiment 11: coating composition according to any of the preceding embodiments, characterized in that the silane-based compound R1 is present in a total amount of 5 to 45 wt.-%, more preferred 10 to 40 wt.-% and most preferred from 12 to 35 wt.-%, based in each case on the total weight of the coating composition.

Embodiment 12: coating composition according to any of the preceding embodiments, characterized in that the sum of the number of carbon atoms in residues R⁴ to R⁶ in general formula (III) is from 3 to 5 or from 5 to 8.

Embodiment 13: coating composition according to any of the preceding embodiments, characterized in that z in general formula (III) is 1, 3 or 4, preferably 1 or 4.

Embodiment 14: coating composition according to any of the preceding embodiments, characterized in that n in general formula (III) is 0 or 2 to 6, preferably 0 or 4.

Embodiment 15: coating composition according to any of the preceding embodiments, characterized in that n in general formula (III) is 0, residues R⁴ and R⁵ are, independently from each other, linear or branched C₃-C₅ alkyl groups and residue R⁶ is a methyl group, with the proviso that the sum of all carbon atoms of residues R⁴ to R⁶ is 8.

Embodiment 16: coating composition according to any of embodiments 1 to 14, characterized in that n in general formula (III) is 1 to 8, preferably 4, and residues R⁴ to R⁶ are, independently from each other, methyl groups.

Embodiment 17: coating composition according to any of the preceding embodiments, characterized in that M in general formula (III) is potassium, lithium or titanium, preferably potassium or titanium.

Embodiment 18: coating composition according to any of the preceding embodiments, characterized in that the at least one catalyst C1 of general formula (III) is a neodecanoate and/or ethyl hexanoate of potassium, lithium or titanium, preferably potassium (I) neodecanoate, titanium (IV) neodecanoate, potassium (I) 2-ethylhexanoate, or titanium (IV) 2-ethylhexanoate.

Embodiment 19: coating composition according to any of the preceding embodiments, characterized in that the at least one catalyst C1 is present in a total amount of 1 mmol to 50 mmol, preferably 5 mmol to 40 mmol, very preferably 15 to 35 mmol metal per 100 g silane-based compound R1 or R2 solid.

Embodiment 20: coating composition according to any of the preceding embodiments, characterized in that the at least one metal alkoxide C2 is selected from metal alkoxides of the general formula (IV)

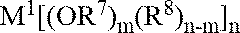

wherein
R⁷ is a linear or branched C₁ to C₁₀ alkyl group,
R⁸ is a halogen group, an acetylacetonate group, an alkyl acetoacetate group or an ethanolaminato group,
M¹ represents at least one metal selected from silicon, titanium, tantalum, zirconium, boron, aluminum, magnesium or zinc,
m is an integer from 0 to 4, and
n represents a valence of 2 to 5 of M¹.

Embodiment 21: coating composition according to embodiment 20, characterized in that the R⁷ in general formula (IV) is selected from a C₃ to C₅ alkyl group, preferably a C₃ or a C₄ alkyl group and/or that R⁷ in general formula (IV) is selected from alkyl acetoacetate groups, preferably from an ethyl acetoacetate group.

Embodiment 22: coating composition according to embodiment 20 or 21, characterized in that m in general formula (IV) is 0 or 1 to 4, more preferably 0 or 2 to 4, very preferably 0, 2 or 4.

Embodiment 23: coating composition according to any of embodiments 20 to 22, characterized in that M¹ in general formula (IV) is a metal selected from titanium and n represents a valence of 4.

Embodiment 24: coating composition according to any of the preceding embodiments, characterized in that the metal alkoxide C2 is selected from titanium (IV) isopropoxide and/or titanium (IV) n-butoxide and/or titanium (IV) bis(ethyl acetoacetate)diisopropoxide, very preferably titanium (IV) isopropoxide.

Embodiment 25: coating composition according to any of the preceding embodiments, characterized in that the at least one metal alkoxide C2, preferably metal alkoxides of general formula (IV), is present in a total amount of 2.5 to 40 mmol metal, based in each case on 100 g silane-based compound R1 solid.

Embodiment 26: coating composition according to any of the preceding embodiments, characterized in that the metal to metal ratio of catalyst C1 of general formula (III) to the at least one metal alkoxide C2, preferably the metal alkoxide of general formula (IV), is from 1:2 to 2:1.

Embodiment 27: coating composition according to any of the preceding embodiments, characterized in that the at least one polymer P1 is selected from homo- or copolymers of unsaturated acids, polyurethanes having at least one group being capable of forming anions, polyurethane (meth)acrylates having at least one group being capable of forming anions and mixtures thereof, preferably homo- or copolymers of unsaturated acids, very preferably homo- or copolymers of unsaturated carboxylic acids.

Embodiment 28: coating composition according to embodiment 27, characterized in that the at least one group being capable of forming anions is selected from carboxylic acid groups, sulfonic acid groups, phosphonic acid groups and mixtures thereof, preferably carboxylic acid groups.

Embodiment 29: coating composition according to any of the preceding embodiments, characterized in that the degree of neutralization of the at least one polymer P1 is 0 to 20%, more preferably 0 to 10%, very preferably 0%.

Embodiment 30: coating composition according to any of the preceding embodiments, characterized in that the at least one polymer P1 comprises - in polymerized form -
(i) at least one unsaturated monomer M1 having at least one group being capable of forming anions;
(ii) optionally at least one unsaturated monomer M2 selected from esters of (meth)acrylic acid having an alkyl radical substituted by at least one hydroxyl group;
(iii) optionally at least one further unsaturated monomer M3 being different from monomers M1 and M2; and
(iv) optionally at least one lactone;
(v) optionally at least one cyclic carboxylic acid anhydride.

Embodiment 31: coating composition according to embodiment 30, characterized in that the at least one monomer M1 is selected from (meth)acrylic acid, ethacrylic acid, crotonic acid, maleic acid, fumaric acid and itaconic acid; olefinically unsaturated sulfonic and phosphonic acids and their partial esters; and mono(meth)acryloyloxyethyl maleate, mono(meth)acryloyloxyethyl succinate, and mono(meth)acryloyloxyethyl phthalate, preferably (meth)acrylic acid, very preferably acrylic acid.

Embodiment 32: coating composition according to embodiment 30 or 31, characterized in that the at least one monomer M1, particularly acrylic acid, is preferably present in a total amount of 1 to 100 wt.-%, preferably 5 to 50 wt.-%, more preferably 10 to 20 wt.-%, very preferably 12 to 17 wt.-%, based on the total amount of compounds (i) to (v).

Embodiment 33: coating composition according to any of embodiments 30 to 32, characterized in that the at least one unsaturated monomer M2 is selected from 2-hydroxyethyl (meth)acrylate, 2-hydroxypropyl (meth)acrylate, 3-hydroxypropyl (meth)acrylate, 3-hydroxybutyl (meth)acrylate, 4-hydroxybutyl (meth)acrylate and mixtures thereof, very preferably 2-hydroxyethyl methacrylate.

Embodiment 34: coating composition according to any of embodiments 30 to 33, characterized in that the at least one unsaturated monomer M2, particularly 2-hydroxyethyl methacrylate, is present in a total amount of 1 to 30 wt.-%, preferably 5 to 25 wt.-%, more preferably 10 to 20 wt.-%, very preferably 12 to 15 wt.-%, based on the total amount of compounds (i) to (v).

Embodiment 35: coating composition according to any of embodiments 30 to 34, characterized in that the polymer P1 comprises the at least one further monomer M3 in a total amount of 1 to 75 wt.-%, preferably 5 to 70 wt.-%, more preferably 10 to 65 wt.-%, very preferably 50 to 60 wt.-%, based in each case on the total amount of compounds (i) to (v).

Embodiment 36: coating composition according to any of embodiments 30 to 35, characterized in that the at least one monomer M3 is selected from alkyl (meth)acrylates (M3-1) and/or unsaturated monomers having at least one aromatic moiety (M3-2).

Embodiment 37: coating composition according to embodiment 36, characterized in that the alkyl (meth)acrylate (M3-1) is selected from methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, n-butylmethyl (meth)acrylate, ethylhexyl (meth)acrylate, 3,3,5-trimethylhexyl (meth)acrylate, stearyl (meth)acrylate, lauryl (meth)acrylate, cycloalkyl (meth)acrylates such as cyclopentyl (meth)acrylate, isobornyl (meth)acrylate, cyclohexyl (meth)acrylate and mixtures thereof, preferably n-butylmethyl acrylate and/or ethylhexyl acrylate.

Embodiment 38: coating composition according to embodiment 36 or 37, characterized in that the unsaturated monomer comprising at least one aromatic group (M3-2) is selected from vinylaromatic compounds, such as styrene, α-methylstryrene, vinyltoluene, t-butylstryrene and mixtures thereof, preferably styrene.

Embodiment 39: coating composition according to any of embodiments 36 to 38, characterized in that the alkyl (met)acrylate (M3-1), particularly n-butylmethyl acrylate and/or ethylhexyl acrylate, is present in the polymer P1 in a total amount of 10 to 60 wt.-%, preferably 30 to 50 wt.-%, more preferably 35 to 50 wt.-%, very preferably 37 to 46 wt.-%, based on the total amount of compounds (i) to (v).

Embodiment 40: coating composition according to any of embodiments 36 to 39, characterized in that the unsaturated monomer comprising at least one aromatic group (M3-2), preferably styrene, is present in the polymer P1 in a total amount of 1 to 30 wt.-%, preferably 5 to 25 wt.-%, more preferably 10 to 20 wt.-%, very preferably 14 to 17 wt.-%, based in each case on the total amount of compounds (i) to (v).

Embodiment 41: coating composition according to any of embodiments 36 to 40, characterized in that the polymer P1 contains a weight ratio of the alkyl (meth)acrylate (M3-1) to the unsaturated monomer comprising at least one aromatic moiety (M3-2) of 5 : 1 to 1 : 1, more preferably 4 : 1 to 1 : 1, very preferably 3 : 1 to 2 : 1.

Embodiment 42: coating composition according to any of embodiments 30 to 41, characterized in that the at least one lactone is selected from compounds of general formula (V)

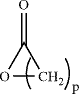

wherein p is an integer from 1 to 10, preferably 1 to 8, more preferably 3 to 6, very preferably 5.

Embodiment 43: coating composition according to any of embodiments 30 to 42, characterized in that the at least one lactone, particularly epsilon-caprolactone, is preferably used in a total amount of 0.5 to 25 wt.-%, preferably 1 to 20 wt.-%, more preferably 5 to 15 wt.-%, very preferably 5 to 11 wt.-%, based on the total amount of compounds (i) to (v).

Embodiment 44: coating composition according to any of embodiments 30 to 43, characterized in that the cyclic carboxylic acid anhydride is selected from aromatic and aliphatic carboxylic acid anhydrides, preferably aliphatic carboxylic acid anhydrides, very preferably hexahydrophthalic anhydride.

Embodiment 45: coating composition according to any of embodiments 30 to 44, characterized in that the polymer P1 contains the at least one cyclic carboxylic anhydride, preferably hexahydrophthalic anhydride, in a total amount of 1 to 30 wt.-%, more preferably 5 to 25 wt.-%, even more preferably 8 to 15 wt.-%, very preferably 5 to 11 wt.-%, based in each case on the total amount of compounds (i) to (v).

Embodiment 46: coating composition according to any of the preceding embodiments, characterized in that the at least one polymer P1 has an acid number of 15 to 400 mg KOH/g solids, preferably 30 to 300 mg KOH/g solids, more preferably 60 to 200 mg KOH/g solids, very preferably 90 to 130 mg KOH/g solids, as determined according to DIN EN ISO 2114:2002-06 (procedure A).

Embodiment 47: coating composition according to any of the preceding embodiments, characterized in that the at last one polymer P1 has a weight average molecular weight M_{w} of 1,000 to 10,000 g/mol, preferably 3,000 to 8,000 g/mol, more preferably 4,000 to 6,000 g/mol, very preferably 4,800 to 5,400 g/mol, as determined according to DIN 55672-1:2016-03.

Embodiment 48: coating composition according to any of the preceding embodiments, characterized in that the at last one polymer P1 has a polydispersity D (M_{w}/Mₙ) of 2.0 to 6.5, preferably 3.0 to 6.0, very preferably 4.3 to 4.8.

Embodiment 49: coating composition according to any of the preceding embodiments, characterized in that the at least one polymer P1 is obtained by
(a) polymerizing a mixture M comprising:
   (i) at last one unsaturated monomer M1 having at least one group being capable of forming anions;
   (ii) optionally at least one unsaturated monomer M2 selected from esters of (meth)acrylic acid having an alkyl radical substituted by at least one hydroxyl group;
   (iii) optionally at least one further monomer M3 being different from monomers M1 and M2;
   (iv) optionally at least one lactone; and
(b) optionally reacting the polymer obtained in step (a) with at least one cyclic carboxylic acid anhydride.

Embodiment 50: coating composition according to embodiment 49 characterized in that the at least one unsaturated monomer M1 having at least one group being capable of forming anions, particularly acrylic acid, is present in the mixture M in a total amount of 5 to 35% by weight, more preferably 7 to 30% by weight, even more preferably 10 to 25% by weight, very preferably 12 to 19% by weight, based on the total amount of mixture M.

Embodiment 51: coating composition according to embodiment 49 or 50, characterized in that the at least one unsaturated monomer M2, particularly 2-hydroxyethyl methacrylate, is used in a total amount of 5 to 30% by weight, more preferably 7 to 25 % by weight, even more preferably 10 to 20% by weight, very preferably 12 to 18% by weight, based on the total amount of mixture M.

Embodiment 52: coating composition according to any of embodiments 49 to 51, characterized in that the at least one unsaturated monomer M3 being different from monomers M1 and M2, particularly n-butylmethyl acrylate and/or ethylhexyl acrylate and/or styrene, is present in a total amount of 40 to 80% by weight, more preferably 45 to 75% by weight, even more preferably 50 to 70% by weight, very preferably 57 to 6 % by weight, based on the total amount of mixture M.

Embodiment 53: coating composition according to any of embodiments 49 to 52, characterized in that the at least one lactone, particularly epsilon-caprolactone, is used in a total amount of 1 to 30% by weight, more preferably 3 to 25% by weight, even more preferably 4 to 20% by weight, very preferably 5 to 13% by weight, based on the total amount of mixture M.

Embodiment 54: coating composition according to any of embodiments 49 to 53, characterized in that 1 to 30% by weight, more preferably 5 to 25% by weight, even more preferably 8 to 20% by weight, very preferably 10 to 15% by weight, based in each case on the total amount of mixture M, of cyclic carboxylic anhydride, preferably hexahydrophthalic anhydride, is reacted with the polymer obtained in step (a).

Embodiment 55: coating composition according to any of the preceding embodiments, characterized in that the at least one polymer P1 is present in a total amount of 0.1 to 15 wt.-%, more preferred 0.5 to 10 wt.-% and most preferred from 1.5 to 8 wt.-%, based in each case on the total weight of the coating composition.

Embodiment 55: coating composition according to any of the preceding embodiments, characterized in that the at least one aprotic solvent is selected from the group consisting of aliphatic and/or aromatic hydrocarbons, ketones, esters, ethers, or mixtures thereof, preferably esters, very preferably butyl acetate.

Embodiment 56: coating composition according to any of the preceding embodiments, characterized in that the coating composition comprises a total amount of water and/or protic solvents of less than 10 wt.-%, preferably less than 5 wt.-%, more preferably less than 1 wt.-%, very preferably 0 wt.-%, based in each case on the total weight of the coating composition.

Embodiment 57: coating composition according to any of the preceding embodiments, characterized in that the at least one aprotic solvent is present in a total amount of 1 to 70 wt.-%, more preferred 20 to 60 wt.-% and most preferred from 30 to 50 wt.-%, based in each case on the total weight of the coating composition.

Embodiment 58: coating composition according to any of the preceding embodiments, characterized in that it further comprises at least one carboxylic acid of general formula (VI)

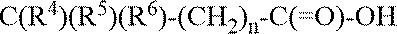

wherein
R⁴ to R⁶ are, independently from each other, hydrogen or alkyl groups containing 1 to 6 carbon atoms, with the proviso that the sum of the number of carbon atoms in residues R⁴ to R⁶ is from 3 to 8, preferably 5 to 8; and
n is 0 or 1 to 8 preferably 0 or 4.

Embodiment 59: coating composition according to embodiment 58, characterized in that the at least one carboxylic acid of general formula (VI) is neodecanoic acid.

Embodiment 60: coating composition according to embodiment 58 or 59, characterized in that the at least one carboxylic acid of general formula (VI), preferably neodecanoic acid, is present in a total amount of 0 to 80 wt.-%, preferably 30 to 70 wt.-%, very preferably 50 to 60 wt.-%, based in each case on the total amount of catalyst C1 of general formula (III).

Embodiment 61: coating composition according to any of the preceding embodiments, characterized in that it further comprises at least one epoxy functional compound of general formula (VII)

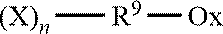

wherein
Ox is an oxirane group;
R⁹ is an aliphatic hydrocarbyl group containing 2 to 15 carbon atoms and optionally comprising ether groups and/or ester groups;
n is 1 to 5; and
X are, independently of each other, Ox or a *—Si(R^{g})₃₋ᵥ(R^{h})ᵥ group where v is 0 or 1, R^{g} is an alkoxy group containing 1 to 4 carbon atoms and R^{h} is an alkyl group containing 1 to 4 carbon atoms or an alkoxy group containing 1 to 4 carbon atoms.

Embodiment 62: coating composition according to embodiment 61, characterized in that R⁹ general formula (VII) is an aliphatic hydrocarbyl group *—(CH₂)₃—O—CH₂—^{#} or a cyclohexyl ethyl group.

Embodiment 63: coating composition according to embodiment 61 or 62, characterized in that n general formula (VII) is 1.

Embodiment 64: coating composition according to any of embodiments 61 to 63, characterized in that X general formula (VII) is a *—Si(R^{g})₃₋ᵥ(R^{h})ᵥ group where v is 0 or 1, R^{g} is an alkoxy group containing 1 to 4 carbon atoms and R^{h} is an alkoxy group containing 1 carbon atom or an alkyl group containing 1 carbon atom.

Embodiment 65: coating composition according to any of embodiments 61 to 64, characterized in that the at least one epoxy compound of general formula (VII) is selected from (3-glycidoxypropyl) trimethoxysilane, dimethoxy(3-glycidyloxypropyl)methylsilane, 2-(3,4-epoxycyclohexyl)ethyltrimethoxysilane, trimethylolpropane triglycidylether and reaction products of 2,2-bis(hydroxymethyl)-1,3-propanediol and 2-(chloromethyl)oxirane, preferably (3-glycidoxypropyl) trimethoxysilane, trimethylolpropane triglycidylether and reaction products of 2,2-bis(hydroxymethyl)-1,3-propanediol and 2-(chloromethyl)oxirane.

Embodiment 66: coating composition according to any of embodiments 61 to 65, characterized in that the at least one epoxy functional compound of general formula (VII) is present in a total amount of 0 to 20 wt.-%, more preferred 2.5 to 15 wt.-% and most preferred from 5 to 10 wt.-%, based in each case on solids content of the coating composition.

Embodiment 67: coating composition according to any of the preceding embodiments, characterized that the coating composition further comprises at least one catalyst C3 different from catalysts C1 and C2, said catalyst C3 being preferably selected from bicyclic tertiary amines, very preferably from DBU.

Embodiment 68: coating composition according to embodiment 67, characterized that the coating composition comprises a weight ratio of catalyst C1 to the further catalyst C3 is preferably from 1:1 to 8:1, more preferred from 2:1 to 6:1 and most preferred from 3:1 to 5:1 such as 4:1.

Embodiment 69: coating composition according to any of the preceding embodiments, characterized in that the coating composition comprises at least one further binder B being different from silane-compound R1 and polymer P1, in a total amount of 0 % by weight, based on the total weight of the coating composition.

Embodiment 70: coating composition according to any of the preceding embodiments, characterized in that it is a clearcoat composition or a tinted clearcoat composition.

Embodiment 71: coating composition according to any of the preceding embodiments, characterized that the coating composition comprises a total amount of less than 2 wt.-%, preferably 0 wt.-%, based on the total weight of the coating composition, of at least one crosslinking agent and/or tin containing compound.

Embodiment 72: coating composition according to embodiment 71, characterized that the crosslinking agent is selected from the group consisting of amino resins, polyisocyanates, blocked polyisocyanates, polycarbodiimides, photoinitiators, and mixtures thereof.

Embodiment 73: coating composition according to any of the preceding embodiments, characterized that it is a two component coating composition, preferably comprising the silane-based compound R1 and, if present, the epoxy functional compound of general formula (VII) in a first container and the catalyst C1, the catalyst C2, the at least one polymer P1, optionally catalyst C3, optionally the at least one coating additive and the at least aprotic solvent in a second container.

Embodiment 74: a method for forming a coating on a substrate (S) comprising the following steps:
(1) applying a coating composition of any of embodiments 1 to 73 on the substrate (S);
(2) forming a coating film from the coating composition applied in step (1); and
(3) curing the coating film formed in step (2).

Embodiment 75: method according to embodiment 74, characterized in that the substrate (S) is selected from metallic substrates, metallic substrates coated with a cured electrocoat and/or a cured filler, plastic substrates and substrates comprising metallic and plastic components, especially preferably from metallic substrates.

Embodiment 76: method according to embodiment 75, characterized in that the metallic substrate is selected from the group comprising or consisting of iron, aluminum, copper, zinc, magnesium and alloys thereof as well as steel.

Embodiment 77: method according embodiment 74, characterized in that the substrate in step (1) is a multilayer coating possessing defect sites.

Embodiment 78: method according to any of claims 74 to 77, characterized in that the formation of the coating film in step (2) is performed at a temperature of 20 to 60° C. for a duration of 5 to 80 minutes, preferably performed at a temperature of 20 to 35° C. for a duration of 5 minutes to 70 minutes.

Embodiment 79: method according to any of embodiments 74 to 78, characterized in that the curing in step (3) is performed at a temperature of 20 to 30° C. for a duration of 10 to 70 minutes, preferably 20 to 60 minutes.

Embodiment 80: coated substrate obtained according to the method of any of embodiments 74 to 79.

Embodiment 81: multilayer coating comprising at least two coating layers, wherein at least one of the coating layers is formed from a coating composition according to any one of embodiments 1 to 73.

Embodiment 82: substrate coated with a multilayer coating as defined in embodiment 81.

### EXAMPLES

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.
1. Methods of determination:
1.1 Solids content (solids, nonvolatile fraction)

The nonvolatile fraction is determined according to DIN EN ISO 3251 (date: June 2008). It involves weighing out 1 g of sample into an aluminum dish which has been dried beforehand, drying it in a drying oven at 130° C. for 60 minutes, cooling it in a desiccator and then reweighing it. The residue relative to the total amount of sample used corresponds to the nonvolatile fraction.

### 1.2 Isocyanate Content (NCO Content)

The isocyanate content was determined by adding an excess of a 2% N,N-dibutylamine solution in xylene to a homogeneous solution of the sample in acetone/N-ethyl pyrrolidone (1:1 vol%), by potentiometric back-titration of the amine excess with 0.1 N hydrochloric acid, in a method based on DIN EN ISO 3251:2008-06, DIN EN ISO 11909:2007-05, and DIN EN ISO 14896:2009-07. The NCO content of the silane-based compound R, based on solids, can be calculated via the fraction of the polymer (solids content) in solution.

### 1.3 Weight Average and Number Average Molecular Weight M_{w}, Mₙ

The weight average molecular weight M_{w} as well as the number average molecular weight Mₙ was determined according to GPC and DIN 55672-1:2016-03 using polystyrene as internal standard.

### 1.4 Acid Number

The acid number of the polymer P1 was determined according to DIN EN ISO 2114:2002-06 (procedure A).

### 1.5 Preparation of Multilayer Coatings (MC)

Steel panels were first pretreated with Gardobond R zinc phosphatation (commercially available from Chemetall GmbH) and afterwards coated with ED-coat (Cathogard 800, commercially available from BASF Coatings GmbH) in a dry film thickness of 17 to 25 µm.

Afterwards, the electrodeposited panels were coated as described below using a pneumatic spray gun at a temperature of 25° C. and a relative humidity of 65%. A primer (Glasurit 285-270, BASF Coatings GmbH) was applied to the electrodeposited panels such that the film thickness after curing at 60° C. was 50 to 70 µm. The primer was subsequently sanded and a commercially available aqueous basecoat (Glasurit Line 90-1250 Deep Black, BASF Coatings GmbH) was applied such that the film thickness after flash-off till touch dry for approximately 30 minutes was 10 to 20 µm. In the last step the respective clearcoat composition C-C1 to C-C4 and C-11 to C-I3 described in Table 1 below was applied on top of the basecoat layer and allowed to cure at ambient conditions till touch dry for approximately 15 to 75 minutes. The dry film thickness of the clearcoat layer was 35 to 80 µm. For each clearcoat C-C1 to C-C4 and C-11 to C-I3, two panels were prepared as previously described.

### 1.6 Test Measurements

### 1.6.1 Tack Free Time

The tack free time is determined by the Guillotine test according to DIN EN ISO 9117-5:2012-11. For this test 1.5 g of sea sand is poured on the clear coat. The excess of sand is poured off from the panel. Afterwards, the panel is transferred to a device (Guillotine) that allows to drop the panel from 30 cm above the surface in a self-falling guided manner. The panel drops with the edge on the surface and is afterwards checked for remaining grains of sand. Remain no grains of sand on the coating surface the Guillotine test is considered OK and the coating “tack free”.

### 1.6.2 Xylene Test

Seven days after preparation of the multilayer coating as previously described, a large drop (around 2 mL) of Xylene is applied on the coating and again removed after 4 minutes. One hour later the surface is cleaned with PK700 cleanser (available from R-M Automotive Refinish Paints) and the coating is examined. The visibility of the edge of the drop is measured in the range 0 to 5 (where 0 means no visible ring and 5 complete removal of the clear coat)

### 1.6.3 Cross-Cut Adhesion

Cross-cut adhesion was performed according to DIN EN ISO 2409:2013-06 seven days after preparation of the multilayer coating as previously described as well as after exposure of the multilayer coating to 40° C. and 100% humidity for 240 h.

### 1.6.4 Stone Chip

Stone chip adhesion test and evaluation was performed according to DIN EN ISO 20567-1:2017-07 and DIN 55996-1:2001-04.

### 1.6.5 Steam Jet Adhesion

Steam jet adhesion was tested according to DIN 55662:2009-12.

### 1.6.6 Visual Evaluation of Blistering, Whitening, Cracks, Swelling and Delamination after Humidity Exposure

Seven days after preparation of the multilayer coating, the respective panel was transferred to a climate chamber with 40° C. and 100% humidity for 240 h. Afterwards, the blistering and whitening was examined visually according to DIN EN ISO 4628-2:2016-07. Evaluation of cracks, swelling and delamination was also performed visually. In case no cracks, swelling or delamination could be detected, the rating for each criteria is “NO”. Otherwise, the rating is “YES”.

### 1.6.7 Appearance Evaluation (Measurement of DOI, Du, Long Wave (LW) and Short Wave (SW))

The measurement of the appearance is carried out by employing a device from BYK, “Wavescan Dual” which is based on a laser measurement under an incident angle of 60°. The device is moved over the surface and the results are recorded depending on the size of the structures. In this context, the SW-values refer to structures in the range between 0.3 and 1.2 mm, the LW-values refer to structures in the range of from 1.2 to 12 mm. A detailed description of the device employed, the measurement method and details about the length scales of the structures dealed with can be found in the literature: BYK - Gardner Instrumente, “Qualitatskontrolle fur Lacke”, 2008,

Glanz/Appearance, available at BYK Gardner, Lausitzer Strasse 8, 82538 Geretsried, Germany.

### 1.6.8 Gloss and Haze Measurements

Gloss and haze were measured using the gloss meter Byk Gardener micro-haze plus which operates according to DIN 67 530, ISO 2813, ASTM D 523 and ASTM E 430.

### 1.6.9 Micropenetration (Martens Hardness)

The micropenetration or Martens hardness was determined according to DIN EN ISO 14577-4:2017-04 (German version).

### 1.6.10 Erichsen Depth

The Erichsen depth was determined according to DIN EN ISO 1520:2007-11 (German version).

### 2. Preparation of Silane-Based Compound R

Silane-based compound R was prepared by reacting 4,4′-methylene bis(cyclohexyl isocyanate) (25.52 g, Desmodur W) with two equivalents N-(n-butyl)-3-aminopropyltrimethoxysilane (44.48 g) in 20 g butyl acetate and 10 g ethyl methyl ketone at 60° C. until the remaining NCO content reached 0%.

### 3. Preparation of Different Acid-Functionalized Polymers P1-1 to P1-3

Different acid-functional polymers P1 each having an acid number of more than 10 mg KOH/g solids were prepared according to the following general procedure using the amounts listed in Table 1 below:

An initiator solution prepared by mixing the respective amount of tert-butylperoxy-2-ethylhexanoate in 10 g solvent naphtha was dosed over 5 h and a monomer mixture M containing the respective amounts of monomers and optionally epsilon-caprolactone was dosed over 4 h into a reactor vessel at 150° C. The dosing of the monomer mixture M was started 15 minutes after the addition of the initiator solution. After dosing of the initiator solution and the monomer mixture M was completed, the temperature was decreased to 102° C. and the respective amount of molten hexahydrophthalic acid anhydride was added. Afterwards the temperature was increased to 120° C. and the reaction was proceeded until an acid number in the range of 120 to 140 mg KOH/g solids was obtained.

The properties of the obtained acid-functional polymers P1-1 to P1-5 are listed in Table 2.

TABLE 1

Amounts used to prepare different acid-functionalized polymers P1 (all amounts are given in grams)

| | | Polymer P1 | | | | |
|---|---|---|---|---|---|---|
| | | P1-1 | P1-2 | P1-3 | P1-4 | P1-5 |
| | tert-butylperoxy-2-ethylhexanoate | 11.39 | 12.07 | 12.83 | 12.64 | 14.22 |
| Monomer mixture M | acrylic acid | 14.96 | 15.86 | 16.86 | 10.55 | 5.62 |
| | 2-hydroxyethyl methacrylate | 14.46 | 15.32 | 16.29 | 11.10 | 6.24 |
| | n-butylmethyl acrylate | 37.16 | 39.37 | 41.86 | 41.25 | 46.40 |
| | ethylhexyl acrylate | 5.49 | 5.82 | 6.19 | 6.10 | 6.86 |
| | styrene | 16.70 | 17.70 | 18.81 | 18.54 | 20.86 |
| | epsilon-caprolactone | 11.23 | 5.93 | 0 | 12.46 | 14.02 |
| | hexahydrophthalic acid anhydride | 11.23 | 11.90 | 12.65 | 7.77 | 4.37 |

TABLE 2

Properties of obtained acid-functionalized polymers P1-1 to P1-5

| | Polymer P1-1 | Polymer P1-2 | Polymer P1-3 | Polymer P1-4 | Polymer P1-5 |
|---|---|---|---|---|---|
| Solids content [%] | 62.4 | 63.8 | 63.0 | 60.0 | 53.1 |
| Acid number [mg KOH g/solids] | 122.5 | 127 | 135 | 95.9 | 61.8 |
| M_{w} [g/mol] | 5151 | 4564 | 3754 | 3682 | 3028 |
| Mₙ [g/mol] | 1150 | 1132 | 1026 | 1174 | 1215 |
| Polydispersity PD | 4.5 | 4.0 | 3.7 | 3.1 | 2.5 |

### 4. Preparation of Clearcoat Compositions C-C1 to C-C4 and C-11 to C-113

The ingredients of the comparative coating compositions C-C1 to C-C4 as well as the ingredients of the inventive coating compositions C-11 to C-113 were mixed in the amounts shown in Table 3. First ingredients I were mixed, and afterwards pre-mixed ingredients II were added. All amounts are in gram. All clearcoat compositions had a non-volatile content of 55.0%.

TABLE 3

Formulation of different clearcoat compositions

| | Ingredients | NVC** | C-C1 | C-C2 | C-C3 | C-C4 | C-l1* | C-l2* | C-l3* |
|---|---|---|---|---|---|---|---|---|---|
| I | Butyl acetate | 0 | 10.85 | 10.18 | 9.30 | 8.43 | 10.40 | 9.95 | 9.55 |
| | Acid-functionalized polymer P1-1 | 61.3 | - | - | - | - | 3.65 | 7.30 | 10.95 |
| | Acid-functionalized polymer P1-2 | 63.8 | - | - | - | - | - | - | - |
| | Acid-functionalized polymer P1-3 | 63.0 | - | - | - | - | - | - | - |
| | Acid-functionalized polymer P1-4 | 60 | - | - | - | - | - | - | - |
| | Acid-functionalized polymer P1-5 | 53.1 | - | - | - | - | - | - | - |
| | Hydroxy-functional polyacrylate ¹⁾ | 55.0 | - | 4.08 | 8.15 | 12.2 | - | - | - |
| | Leveling additive BYK 333 ⁴⁾ | 10 | 0.50 | 0.50 | 0.50 | 0.50 | 0.50 | 0.50 | 0.50 |
| | Catalyst C1 ²⁾ | 90 | 2.28 | 2.28 | 2.28 | 2.28 | 2.28 | 2.28 | 2.28 |
| | Catalyst C2 ³⁾ | 97 | 0.70 | 0.70 | 0.70 | 0.70 | 0.70 | 0.70 | 0.70 |
| | Tinuvin 152 ⁵⁾ | 20 | 1.45 | 1.45 | 1.45 | 1.45 | 1.45 | 1.45 | 1.45 |
| | Tinuvin 400 ⁶⁾ | 85 | 0.45 | 0.45 | 0.45 | 0.45 | 0.45 | 0.45 | 0.45 |
| II | Silane-based compound R | 69.7 | 32.10 | 28.7 | 25.5 | 22.3 | 28.90 | 25.70 | 22.45 |
| | (3-glycidyloxypropyl)-trimethoxysilane | 100 | 1.68 | 1.68 | 1.68 | 1.68 | 1.68 | 1.68 | 1.68 |

* inventive ** NVC = non-volatile content ¹⁾ prepared by radical polymerization of a monomer mixture containing 20 wt.-% of styrene, 15 wt.-% n-butyl methacrylate, 20 wt.-% hydroxypropyl methacrylate, 18 wt.-% 2-hydroxyethyl methacrylate, 1 wt.-% acrylic acid, 26 wt.-% of cyclohexyl methacrylate (OH-number (calculated: 152 to 160 mg KOH/g solids , acid number: 8 to 10 mg KOH/g solids) ²⁾ potassium neodecanoate (contains 56% by weight, based on the total weight of catalyst C1, of neodecanoic acid), ³⁾ metal alkoxide of general formula (IV) with R⁷ = branched C₃ alkyl group, m = 4, n = 4 and M¹ = Ti (titanium content: 29.7%) ⁴⁾ polyether modified polydimethylsiloxane (leveling additive, supplied by BYK Chemie GmbH) ⁵⁾ HALS (supplied by BASF SE) ⁶⁾ liquid hydroxyphenyl-triazine (HPT) UV absorber (supplied by BASF SE)

TABLE 3

Formulation of different clearcoat compositions - continued

| | Ingredients | NVC** | C-l4* | C-l5* | C-l6* | C-l7* | C-l8* | C-l9* | C-l10* | C-l11* | C-l12* | C-l13* |
|---|---|---|---|---|---|---|---|---|---|---|---|---|
| I | Butyl acetate | 0 | 10.30 | 10.00 | 10.23 | 9.88 | 10.53 | 10.00 | 9.48 | 10.05 | 9.03 | 8.00 |
| | Acid-functionalized polymer P1-1 | 61.3 | - | - | - | - | - | - | - | - | - | - |
| | Acid-functionalized polymer P1-2 | 63.8 | 7.03 | 10.53 | - | - | - | - | - | - | - | - |
| | Acid-functionalized polymer P1-3 | 63.0 | - | - | 7.10 | 10.65 | - | - | - | - | - | - |
| | Acid-functionalized polymer P1-4 | 60 | - | - | - | - | 3.73 | 7.45 | 11.18 | - | - | - |
| | Acid-functionalized polymer P1-5 | 53.1 | - | - | - | - | - | - | - | 4.20 | 8.43 | 12.66 |
| | Hydroxy-functional polyacrylate ¹⁾ | 55.0 | - | - | - | - | - | - | - | - | - | - |
| | Leveling additive BYK 333 ⁴⁾ | 10 | 0.50 | 0.50 | 0.50 | 0.50 | 0.50 | 0.50 | 0.50 | 0.50 | 0.50 | 0.50 |
| | Catalyst C1 ²⁾ | 90 | 2.28 | 2.28 | 2.28 | 2.28 | 2.28 | 2.28 | 2.28 | 2.28 | 2.28 | 2.28 |
| | Catalyst C2 ³⁾ | 97 | 0.70 | 0.70 | 0.70 | 0.70 | 0.70 | 0.70 | 0.70 | 0.70 | 0.70 | 0.70 |
| | Tinuvin 152 ⁵⁾ | 20 | 1.45 | 1.45 | 1.45 | 1.45 | 1.45 | 1.45 | 1.45 | 1.45 | 1.45 | 1.45 |
| | Tinuvin 400 ⁶⁾ | 85 | 0.45 | 0.45 | 0.45 | 0.45 | 0.45 | 0.45 | 0.45 | 0.45 | 0.45 | 0.45 |
| II | Silane-based compound R | 69.7 | 25.63 | 22.43 | 25.63 | 22.43 | 28.71 | 25.51 | 22.31 | 28.71 | 25.51 | 22.31 |
| | (3-glycidyloxypropyl)-trimethoxysilane | 100 | 1.68 | 1.68 | 1.68 | 1.68 | 1.68 | 1.68 | 1.68 | 1.68 | 1.68 | 1.68 |

* inventive
** NVC = non-volatile content
¹⁾ prepared by radical polymerization of a monomer mixture containing 20 wt.-% of styrene, 15 wt.-% n-butyl methacrylate, 20 wt.-% hydroxypropyl methacrylate, 18 wt.-% 2-hydroxyethyl methacrylate, 1 wt.-% acrylic acid, 26 wt.-% of cyclohexyl methacrylate (OH-number (calculated: 152 to 160 mg KOH/g solids , acid number: 8 to 10 mg KOH/g solids)
²⁾ potassium neodecanoate (contains 56% by weight, based on the total weight of catalyst C1, of neodecanoic acid),
³⁾ metal alkoxide of general formula (IV) with R⁷ = branched C₃ alkyl group, m = 4, n = 4 and M¹ = Ti (titanium content: 29.7%)
⁴⁾ polyether modified polydimethylsiloxane (leveling additive, supplied by BYK Chemie GmbH)
⁵⁾ HALS (supplied by BASF SE)
⁶⁾ liquid hydroxyphenyl-triazine (HPT) UV absorber (supplied by BASF SE)

5. Results The results obtained for the multilayer coatings prepared according to point 1.3 using the clearcoat compositions C-C1 to C-C4 and C-l1 to C-113 are listed in Tables 4 to 7.

TABLE 4

Results of performance multilayer coatings MC1 to MC17 (in the upper half of this table, only the differences with regard to theingredients of the inventive and comparative examples are listed)

| Clearcoat composition | | MC1 | MC2 | MC3 | MC4 | MC5* | MC6* | MC7* |
|---|---|---|---|---|---|---|---|---|
| | | C-C1 | C-C2 | C-C3 | C-C4 | C-l1 | C-l2 | C-l3 |
| Butyl acetate | | 10.85 | 10.18 | 9.30 | 8.43 | 10.40 | 9.95 | 9.55 |
| Acid-functionalized polymer P1-1 | | - | - | - | - | 3.65 | 7.30 | 10.95 |
| Acid-functionalized polymer P1-2 | | - | - | - | - | - | - | - |
| Acid-functionalized polymer P1-3 | | - | - | - | - | - | - | - |
| Acid-functionalized polymer P1-4 | | - | - | - | - | - | - | - |
| Acid-functionalized polymer P1-5 | | - | - | - | - | - | - | - |
| Hydroxy-functional polyacrylate | | - | 4.08 | 8.15 | 12.2 | - | - | - |
| Silane-based compound R | | 32.10 | 28.7 | 25.5 | 22.3 | 28.90 | 25.70 | 22.45 |
| Tack free time [min] | | 30 | 30 | 30 | 30 | 45 | 60 | 75 |
| 7 d after preparation | Xylene test | 0 | 0 | 0 | 0 | 0 | 2 | 2 |
| | Cross-cut adhesion | 0 | 2 | 0 | 1 | 0 | 0 | 0 |
| | Stone chip | 2 | 2 | 2 | 2 | 2 | 2 | 2 |
| | Steam jet | 5 | 5 | 5 | 5 | 5 | 5 | 4 |
| After 240 h at 40° C. and 100% humidity | Cross-cut adhesion | 3 | 5 | 4 | 5 | 5 | 5 | 3 |
| | Stone chip | 2.5 | 2.5 | 2.0 | 2.5 | 2.0 | 2.5 | 2.0 |
| | Steam jet | 5 | 1 | 3 | 5 | 5 | 5 | 1 |

* inventive

TABLE 4

Results of performance multilayer coatings MC1 to MC17 (in the upper half of this table, only the differences with regard to the ingredients of the inventive and comparative examples are listed) - continued

| Clearcoat composition | | MC8* | MC9* | MC10* | MC11* | MC12* | MC13* | MC14* | MC15* | MC16* | MC17* |
|---|---|---|---|---|---|---|---|---|---|---|---|
| | | C-l4 | C-l5 | C-l6 | C-l7 | C-l8 | C-l9 | C-l10 | C-l11 | C-l12 | C-l13 |
| Butyl acetate | | 10.30 | 10.00 | 10.23 | 9.88 | 10.53 | 10.00 | 9.48 | 10.05 | 9.03 | 8.00 |
| Acid-functionalized polymer P1-1 | | - | - | - | - | - | - | - | - | - | - |
| Acid-functionalized polymer P1-2 | | 7.03 | 10.53 | - | - | - | - | - | - | - | - |
| Acid-functionalized polymer P1-3 | | - | - | 7.10 | 10.65 | - | - | - | - | - | - |
| Acid-functionalized polymer P1-4 | | - | - | - | - | 3.73 | 7.45 | 11.18 | - | - | - |
| Acid-functionalized polymer P1-5 | | - | - | - | - | - | - | - | 4.20 | 8.43 | 12.66 |
| Hydroxy-functional polyacrylate | | - | - | - | - | - | - | - | - | - | - |
| Silane-based compound R | | 25.63 | 22.43 | 25.63 | 22.43 | 28.71 | 25.51 | 22.31 | 28.71 | 25.51 | 22.31 |
| 7 d after preparation | Tack free time [min] | 60 | 75 | 75 | 75 | 30 | 45 | 60 | 30 | 45 | 60 |
| | Xylene test | 0 | 0 | 0 | 0 | 0 | 1 | 2 | 1 | 0 | 2 |
| | Cross-cut adhesion | 0 | 1 | 0 | 0 | 3 | 1 | 0 | 0 | 3 | 5 |
| | Stone chip | 2.5 | 2.5 | 2.5 | 2.5 | 2.5 | 2.5 | 2.0 | 2.5 | 2.5 | 2.5 |
| | Steam jet | 1 | 5 | 1 | 0 | 5 | 5 | 5 | 5 | 5 | 5 |
| After 240 h at 40° C. and 100% humidity | Cross-cut adhesion | 3 | 2 | 2 | 2 | 5 | 5 | 3 | 5 | 5 | 5 |
| | Stone chip | 2.5 | 2.5 | 2.5 | 2.5 | 2.5 | 2.5 | 2.5 | 2.0 | 2.5 | 3.0 |
| | Steam jet | 1 | 1 | 1 | 5 | 5 | 5 | 5 | 5 | 5 | 5 |

* inventive

TABLE 5

Results of visual inspection of multilayer coatings MC1′ to MC17′ after removing the respective panels from the constant climate chamber (in the upper half of this table, only the differences with regard to the ingredients of the inventive and comparative examples are listed)

| Clearcoat composition | | MC1′ | MC2′ | MC3′ | MC4′ | MC5′* | MC6′* | MC7′* |
|---|---|---|---|---|---|---|---|---|
| | | C-C1 | C-C2 | C-C3 | C-C4 | C-l1 | C-l2 | C-l3 |
| Butyl acetate | | 10.85 | 10.18 | 9.30 | 8.43 | 10.40 | 9.95 | 9.55 |
| Acid-functionalized polymer P1-1 | | - | - | - | - | 3.65 | 7.30 | 10.95 |
| Acid-functionalized polymer P1-2 | | - | - | - | - | - | - | - |
| Acid-functionalized polymer P1-3 | | - | - | - | - | - | - | - |
| Acid-functionalized polymer P1-4 | | - | - | - | - | - | - | - |
| Acid-functionalized polymer P1-5 | | - | - | - | - | - | - | - |
| Hydroxy-functional polyacrylate | | - | 4.08 | 8.15 | 12.2 | - | - | - |
| Silane-based compound R | | 32.10 | 28.7 | 25.5 | 22.3 | 28.90 | 25.70 | 22.45 |
| 1 h after removal | Whitening | Minimal | No | No | No | Slightly | Minimal | No |
| | Cracks | No | No | No | No | No | No | No |
| | Delamination | No | No | Slightly | Slightly | No | No | No |
| 24 h after removal | Whitening | Slightly | No | White | White | White | Slightly | Minimal |
| | Cracks | No | No | No | No | No | No | No |
| | Delamination | No | No | Slightly | Slightly | No | No | No |

* inventive

TABLE 5

Results of visual inspection of multilayer coatings MC1′ to MC17′ after removing the respective panels from the constant climate chamber (in the upper half of this table, only the differences with regard to the ingredients of the inventive and comparative examples are listed) - continued

| Clearcoat composition | | MC8′* | MC9′* | MC10′* | MC11′* | MC12′* | MC13′* | MC14′* | MC15′* | MC16′* | MC17′* |
|---|---|---|---|---|---|---|---|---|---|---|---|
| | | C-I4 | C-I5 | C-I6 | C-I7 | C-I8 | C-I9 | C-I10 | C-I11 | C-I12 | C-113 |
| Butyl acetate | | 10.30 | 10.00 | 10.23 | 9.88 | 10.53 | 10.00 | 9.48 | 10.05 | 9.03 | 8.00 |
| Acid-functionalized polymer P1-1 | | - | - | - | - | - | - | - | - | - | - |
| Acid-functionalized polymer P1-2 | | 7.03 | 10.53 | - | - | - | - | - | - | - | - |
| Acid-functionalized polymer P1-3 | | - | - | 7.10 | 10.65 | - | - | - | - | - | - |
| Acid-functionalized polymer P1-4 | | - | - | - | - | 3.73 | 7.45 | 11.18 | - | - | - |
| Acid-functionalized polymer P1-5 | | - | - | - | - | - | - | - | 4.20 | 8.43 | 12.66 |
| Hydroxy-functional polyacrylate | | - | - | - | - | - | - | - | - | - | - |
| Silane-based compound R | | 25.63 | 22.43 | 25.63 | 22.43 | 28.71 | 25.51 | 22.31 | 28.71 | 25.51 | 22.31 |
| 1 h after removal | Whitening | Slightly | Slightly | Slightly | No | Minimal | Minimal | Minimal | Minimal | Slightly | White |
| | Cracks | No | No | No | No | No | No | No | No | No | No |
| | Delamination | No | No | No | No | No | No | No | No | No | No |
| 24 h after removal | Whitening | Slightly | White | Slightly | Minimal | Slightly | Minimal | No | Slightly | Minimal | Minimal |
| | Cracks | No | No | No | No | No | No | No | No | No | No |
| | Delamination | No | No | No | No | No | No | No | No | No | No |

* inventive

TABLE 6

Results of multilayer coatings MC1 to MC17 with respect to various appearance parameters (in the upper half of this table, only the differences with regard to the ingredients of the inventive and comparative examples are listed)

| Clearcoat composition | MC1 | MC2 | MC3 | MC4 | MC5* | MC6* | MC7* |
|---|---|---|---|---|---|---|---|
| | C-C1 | C-C2 | C-C3 | C-C4 | C-I1 | C-I2 | C-I3 |
| Butyl acetate | 10.85 | 10.18 | 9.30 | 8.43 | 10.40 | 9.95 | 9.55 |
| Acid-functionalized polymer P1-1 | - | - | - | - | 3.65 | 7.30 | 10.95 |
| Acid-functionalized polymer P1-2 | - | - | - | - | - | - | - |
| Acid-functionalized polymer P1-3 | - | - | - | - | - | - | - |
| Acid-functionalized polymer P1-4 | - | - | - | - | - | - | - |
| Acid-functionalized polymer P1-5 | - | - | - | - | - | - | - |
| Hydroxy-functional polyacrylate | - | 4.08 | 8.15 | 12.2 | - | - | - |
| Silane-based compound R | 32.10 | 28.7 | 25.5 | 22.3 | 28.90 | 25.70 | 22.45 |
| DOI | 91.7 | 93.3 | 90.9 | 92.7 | 95.4 | 95.2 | 94.8 |
| du | 1.4 | 1.3 | 1.6 | 1.1 | 1.0 | 1.0 | 1.0 |
| Long Wave | 6.5 | 5.4 | 4.5 | 2.4 | 1.8 | 3.1 | 2.8 |
| Short Wave | 28.0 | 16.8 | 27.7 | 24.2 | 12.5 | 14.5 | 16.2 |
| Gloss | 85.9 | 86.3 | 85.6 | 86.8 | 86.1 | 85.7 | 86.5 |
| Haze | 18.5 | 18.6 | 17.1 | 18.6 | 17.5 | 19.3 | 18.6 |

* inventive

TABLE 6

Results of multilayer coatings MC1 to MC17 with respect to various appearance parameters (in the upper half of this table, only the differences with regard to the ingredients of the inventive and comparative examples are listed) - continued

| Clearcoat composition | MC8* | MC9* | MC10* | MC11* | MC12* | MC13* | MC14* | MC15* | MC16* | MC17* |
|---|---|---|---|---|---|---|---|---|---|---|
| | C-I4 | C-I5 | C-I6 | C-I7 | C-I8 | C-I9 | C-I10 | C-I11 | C-I12 | C-113 |
| Butyl acetate | 10.30 | 10.00 | 10.23 | 9.88 | 10.53 | 10.00 | 9.48 | 10.05 | 9.03 | 8.00 |
| Acid-functionalized polymer P1-1 | - | - | - | - | - | | - | - | - | - |
| Acid-functionalized polymer P1-2 | 7.03 | 10.53 | - | - | - | - | - | - | - | - |
| Acid-functionalized polymer P1-3 | - | - | 7.10 | 10.65 | - | - | - | - | - | - |
| Acid-functionalized polymer P1-4 | - | - | - | - | 3.73 | 7.45 | 11.18 | - | - | - |
| Acid-functionalized polymer P1-5 | - | - | - | - | - | - | - | 4.20 | 8.43 | 12.66 |
| Hydroxy-functional polyacrylate | - | - | - | - | - | - | - | - | - | - |
| Silane-based compound R | 25.63 | 22.43 | 25.63 | 22.43 | 28.71 | 25.51 | 22.31 | 28.71 | 25.51 | 22.31 |
| DOI | 95.8 | 95.5 | 95.5 | 94.3 | 93.2 | 94.0 | 93.9 | 94.7 | 94.9 | 92.4 |
| du | 1.0 | 1.0 | 1.0 | 1.0 | 1.0 | 1.0 | 1.0 | 1.0 | 1.0 | 1.0 |
| Long Wave | 1.0 | 1.5 | 1.2 | 4.5 | 2.6 | 2.5 | 2.0 | 2.1 | 2.0 | 2.4 |
| Short Wave | 8.9 | 11.1 | 11.1 | 15.9 | 19.8 | 19.1 | 17.7 | 15.6 | 15.7 | 23.4 |
| Gloss | 86.5 | 86.7 | 86.2 | 86.8 | 86.2 | 85.2 | 86.7 | 86.6 | 86.5 | 86.2 |
| Haze | 16.6 | 17.2 | 17.5 | 16.9 | 19.0 | 20.3 | 15.5 | 17.0 | 16.3 | 16.5 |

* inventive

TABLE 7

Results of multilayer coatings MC1 to MC7, and MC12 to MC17 with respect to hardness (in the upper half of this table, only the differences with regard to the ingredients of the inventive and comparative examples are listed)

| Clearcoat composition | MC1 | MC2 | MC3 | MC4 | MC5* | MC6* | MC7* |
|---|---|---|---|---|---|---|---|
| | C-C1 | C-C2 | C-C3 | C-C4 | C-I1 | C-I2 | C-I3 |
| Butyl acetate | 10.85 | 10.18 | 9.30 | 8.43 | 10.40 | 9.95 | 9.55 |
| Acid-functionalized polymer P1-1 | - | - | - | - | 3.65 | 7.30 | 10.95 |
| Acid-functionalized polymer P1-4 | - | - | - | - | - | - | - |
| Acid-functionalized polymer P1-5 | - | - | - | - | - | - | - |
| Hydroxy-functional polyacrylate | - | 4.08 | 8.15 | 12.2 | - | - | - |
| Silane-based compound R | 32.10 | 28.7 | 25.5 | 22.3 | 28.90 | 25.70 | 22.45 |
| Micropenetration | 102.74 | 113 | 82 | 69 | 101.18 | 78.98 | 66.84 |
| Micropenetration after humidity | 108.69 | n.d. | n.d. | n.d. | 92.37 | 91.53 | 88.15 |
| Erichsen depth (average of 3) | 2.2 | 5.6 | 3.5 | 3.3 | 3.3 | 4.6 | 4.9 |

* inventive

TABLE 7

Results of multilayer coatings MC1 to MC7, and MC12 to MC17 with respect to hardness (in the upper half of this table, only the differences with regard to the ingredients of the inventive and comparative examples are listed) - continued

| Clearcoat composition | MC12* | MC13* | MC14* | MC15* | MC16* | MC17* |
|---|---|---|---|---|---|---|
| | C-I8 | C-I9 | C-I10 | C-I11 | C-I12 | C-113 |
| Butyl acetate | 10.53 | 10.00 | 9.48 | 10.05 | 9.03 | 8.00 |
| Acid-functionalized polymer P1-1 | - | - | - | - | - | - |
| Acid-functionalized polymer P1-4 | 3.73 | 7.45 | 11.18 | | | |
| Acid-functionalized polymer P1-5 | | | | 4.20 | 8.43 | 12.66 |
| Hydroxy-functional polyacrylate | | | | | | |
| Silane-based compound R | 28.71 | 25.51 | 22.31 | 28.71 | 25.51 | 22.31 |
| Micropenetration | 81.80 | 60.69 | 46.01 | 75.63 | 55.16 | 41.30 |
| Micropenetration after humidity | n.d. | n.d. | n.d. | n.d. | n.d. | n.d. |
| Erichsen depth (average of 3) | 3.1 | 5.0 | 4.9 | 3.6 | 3.8 | 5.1 |

* inventive

Addition of the acid-functional polymer P1-1 comprising 11% by weight, based on compounds (i) to (v), of epsilon-caprolactone to the inventive coating compositions C-11 to C-I3 does not have a negative impact on the stone-chip resistance of the resulting multilayer coatings (MC-5 to MC-7) compared to comparative multilayer coatings MC-1 to MC-4. No negative effect on the stone-chip resistance was also observed upon addition of acid-functional polymer P1-2 having a lower content of epsilon-caprolactone or acid-functional polymers P1-4 and P1-5 having higher amounts of epsilon-caprolactone but lower acid numbers compared to acid-functional polymer P1-1. Increasing amounts of acid-functional polymer P1-1 in the inventive clearcoat compositions (C-11 to C-I3) result in improved steam jet adhesion and cross-cut adhesion, both after preparation and after treatment of the multilayer coatings under humidity conditions. An improved steam jet adhesion and cross-cut adhesion, both after preparation and after treatment of multilayer coatings under humidity conditions, was also obtained when acid-functional polymer P1-2 comprising only 5.9 % by weight of epsilon-caprolactone, acid-functional polymer P1-3 being free of epsilon-caprolactone, acid-functional polymer P1-4 comprising 12.5% by weight of epsilon-caprolactone having an acid number of 95.9 mg KOH/g solids, or acid-functional polymer P1-5 comprising 14.0% by weight of epsilon-caprolactone having an acid number of only 61.8 mg KOH/g solids was used in inventive coating compositions C-I4to C-113 (see Table 4).

Addition of small amounts of hydroxy-functional polyacrylate having an acid number of less than 10 mg KOH/g solids to comparative clearcoat composition C-C2 results in reduced whitening of the resulting multilayer MC-2′ under humidity conditions as compared to multilayer MC1′ being prepared from a clearcoat composition not comprising a hydroxy-functional polyacrylate. However, addition of higher amounts of hydroxy-functional polyacrylate (comparative multilayers MC-3′ and MC-4′) results in a negative impact on the blistering, whitening and delamination of the resulting multilayer coatings. Surprisingly, use of acid-functional polymers P1-1 to P1-5 in increasing amounts in the inventive clearcoat materials C-11 to C-113 reduces the whitening (inventive multilayers MC-5′ to MC-17′) as compared to comparative multilayer coating MC-1′ not comprising a hydroxy- and acid-functional polymer and comparative multilayer coatings MC-3′ and MC-4′ comprising comparative amounts of hydroxy-functional polymer (Table 5).

As is apparent from Table 6, the addition of the acid-functional polymers P1-1 to P1-5 to inventive clearcoat materials C-11 to C-113 results in significantly improved appearance (due to the reduced long wave and short wave values as well as increased DOI) without a negative influence on the du, the gloss and the haze of the resulting inventive multilayer coatings MC-5 to MC-17 compared to non-inventive multilayer coating MC-1 prepared from clearcoat composition C-C1 not comprising an acid-functional polymer. Surprisingly, the significantly improved appearance is only obtained if acid functional polymers having an acid number of at least 10 mg KOH/g solids are used while the use of a hydroxy-functional polymer having an acid number of less than 10 mg KOH/g solids (comparative multilayer coatings MC-2 to MC-4) does only result in a slight or no improvement of appearance.

Addition of the acid-functional polymer P1-1, P1-4 or P1-5 also results in an improved flexibility of the inventive multilayer coatings MC-5 to MC-7, MC12 to MC14 or MC15 to MC17 compared to multilayer coating MC-1. In contrast, higher amounts of hydroxy-functional polymer are needed (MC-3, MC-4) to obtain an improved flexibility as compared to multilayer coating MC-1 (Table 7).

In summary, addition of an acid-functional polymer P1 to a clearcoat material comprising a silane-based compound R and a mixture of catalysts C1 and C2 (C-11 to C-17) leads to significantly improved appearance and flexibility as well as steam jet adhesion under humidity conditions of the resulting multilayer coatings (MC-5 to MC-11 and MC-5′ to MC-11′) without a significant negative influence on the gloss, haze, stone chipping, solvent resistance and cross-cut adhesion compared to multilayer coatings MC-1 being prepared from comparative clearcoat material C-C1 not comprising an acid-functional polymer P1. Surprisingly, the improved appearance as well as improved flexibility is not obtained for multilayer coatings MC-2 to MC-4 being prepared from a clearcoat material comprising an hydroxy-functional polymer having an acid number of less than 10 mg KOH/g in addition to the silane-based compound R and the mixture of catalysts C1 and C2 (C-C2 to C-C4). The beneficial properties of the inventive multilayer coatings can be obtained without the use of undesirable crosslinkers, like polyisocyanates and melamine resins, and tin containing catalysts.

Moreover, the inventive compositions can be cured at ambient temperature, thus rendering them especially suitable for refinish applications.

1. A coating composition comprising:
a) at least one silane-based compound R1 having an isocyanate content of less than 1% and comprising at least one silane group of general formula (I) 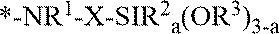
and optionally at least one silane group of general formula (II) 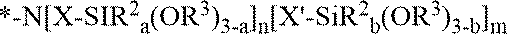
wherein
X, X′ are, independently from each other, selected from the group consisting of linear and/or branched alkylene and cycloalkylene radicals having 1 to 20 carbon atoms,
R¹ is an alkyl group containing 1 to 10 carbon atoms,
R², R³ are, independently from each other, selected from the group consisting of alkyl, cycloalkyl, aryl, and aralkyl groups, it being possible for a carbon chain of the alkyl, cycloalkyl, aryl, and aralkyl groups to be interrupted by nonadjacent oxygen, sulfur or NRₐ groups, where Rₐ is alkyl, cycloalkyl, aryl, or aralkyl,
m, n are, independently from each other, 0 to 1 with a proviso that m+n = 2, and
a, b are, independently from each other, 0 to 2;
b) at least one catalyst C1 of general formula (III) 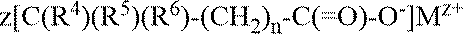
wherein
R⁴ to R⁶ are, independently from each other, selected from the group consisting of hydrogen or alkyl groups containing 1 to 6 carbon atoms, with a proviso that a sum of a number of carbon atoms in residues R⁴ to R⁶ ranges from 3 to 8;
z is 1 to 4; and
n is 0 or 1 to 8
with a proviso that,
if z = 1, then M is selected from the group consisting of Li, K and Na;
if z = 2, then M is selected from the group consisting of Zn and Zr;
if z = 3, then M is selected from the group consisting of Bi and Al; or
if z = 4, then M is selected from the group consisting of Zr and Ti;
c) at least one metal alkoxide C2;
d) at least one polymer P1 having an acid number of more than 10 mg KOH/g solids, as determined according to DIN EN ISO 2114:2002-06; and
e) one or more aprotic organic solvents.

2. The coating composition according to claim 1, wherein
X and X′ in general formulae (I) and (II) represent, independently from each other, a linear alkylene radical having 1 to 10 carbon atoms; and/or
R¹ in general formula (I) is an alkyl group containing 2 to 8 carbon atoms; and/or
R³ in general formulae (I) and (II) represent, independently from each other, a C₁-C₁₀ alkyl group; and/or a in general formulae (I) and (II) is 0; and/or
b in formula (II) is 0.

3. The coating composition according to claim 1, wherein the silane-based compound R¹ is present in a total amount of 5 to 45 wt.-%, based on a total weight of the coating composition.

4. The coating composition according to claim 1, wherein the at least one catalyst C1 of general formula (III) is a neodecanoate and/or ethyl hexanoate of potassium, lithium or titanium.

5. The coating composition according to claim 1, wherein the at least one catalyst C1 is present in a total amount of 1 mmol to 50 mmol metal per 100 g of the silane-based compound R¹ solid.

6. The coating composition according to claim 1, wherein the at least one metal alkoxide C2 is selected from the group consisting of metal alkoxides of the general formula (IV) M¹[(OR⁷)ₘ(R⁸)ₙ₋ₘ]ₙ (IV) wherein
R⁷ is a linear or branched C₁ to C₁₀ alkyl group,
R⁸ is a halogen group, an acetylacetonate group, an alkyl acetoacetate group or an ethanolaminato group,
M¹ represents at least one metal selected from the group consisting of silicon, titanium, tantalum, zirconium, boron, aluminum, magnesium and zinc,
m is an integer from 0 to 4, and
n represents a valence of 2 to 5 of M¹.

7. The coating composition according to claim 1, wherein the metal alkoxide C2 is selected from the group consisting of titanium (IV) isopropoxide, titanium (IV) n-butoxide, and titanium (IV) bis(ethyl acetoacetate)diisopropoxide.

8. The coating composition according to claim 1, wherein the at least one metal alkoxide C2 is present in a total amount of 2.5 to 40 mmol metal, based on 100 g of the silane-based compound R1 solid.

9. The coating composition according to claim 1, wherein the at least one polymer P1 has an acid number of 15 to 400 mg KOH/g solids, as determined according to DIN EN ISO 211 4:2002-06.

10. The coating composition according to claim 1, wherein the coating composition is a clearcoat composition or a tinted clearcoat composition.

11. The coating composition according to claim 1, wherein the coating composition comprises a total amount of less than 2 wt.-%, based on a total weight of the coating composition, of at least one crosslinking agent and/or tin containing compound.

12. A method for forming a coating on a substrate (S) comprising the following steps:
(1) applying a coating composition according to claim 1 on the substrate (S);
(2) forming a coating film from the coating composition applied in step (1); and
(3) curing the coating film formed in step (2).

13. A coated substrate obtained according to the method of claim 12.

14. A multilayer coating comprising at least two coating layers, wherein at least one of the coating layers is formed from the coating composition according to claim 1.

15. A substrate coated with the multilayer coating according to claim 14.

16. The coating composition according to claim 1, wherein
X and X′ in general formulae (I) and (II) represent, independently from each other, a linear alkylene radical having 1 to 6 carbon atoms; and/or
R¹ in general formula (I) is an alkyl group containing 2 to 8 carbon atoms; and/or
R³ in general formulae (I) and (II) represent, independently from each other, a C₁-C₁₀ alkyl group; and/or
a in general formulae (I) and (II) is 0; and/or
b in formula (II) is 0.

17. The coating composition according to claim 1, wherein
X and X′ in general formulae (I) and (II) represent, independently from each other, a linear alkylene radical having 1 to 10 carbon atoms; and/or
R¹ in general formula (I) is an alkyl group containing 4 to 6 carbon atoms; and/or
R³ in general formulae (I) and (II) represent, independently from each other, a C₁-C₁₀ alkyl group; and/or
a in general formulae (I) and (II) is 0; and/or
b in formula (II) is 0.

18. The coating composition according to claim 1, wherein
X and X′ in general formulae (I) and (II) represent, independently from each other, a linear alkylene radical having 1 to 10 carbon atoms; and/or
R¹ in general formula (I) is an alkyl group containing 2 to 8 carbon atoms; and/or
R³ in general formulae (I) and (II) represent, independently from each other, a C₁-C₆ alkyl group; and/or
a in general formulae (I) and (II) is 0; and/or
b in formula (II) is 0.

19. The coating composition according to claim 1, wherein the silane-based compound R1 is present in a total amount of 10 to 40 wt.-%, based on a total weight of the coating composition.

20. The coating composition according to claim 1, wherein the at least one catalyst C1 of general formula (III) is potassium (I) neodecanoate, potassium (I) 2-ethylhexanoate, titanium (IV) neodecanoate or titanium (IV) 2-ethylhexanoate.
